(19) United States
(12) Patent Application Publication
(10) Pub. No.: US 2006/0184271 A1
(43) Pub. Date: Aug. 17, 2006

(54) Cartridge-loaded automatic prescription pill dispensing system and dispensing unit and cartridge for use therein

(76) Inventor: Calvin J. Loveless, Stittsville (CA)

Correspondence Address: ADAMS PATENT & TRADEMARK AGENCY, P.O. BOX 11100, STATION H, OTTAWA, ON, K2H 7T8, CA

(21) Appl. No.: 11/284,948

(22) Filed: Nov. 23, 2005

(30) Foreign Application Priority Data
Feb. 17, 2005 (CA) 2,498,496

(51) Int. Cl. G06F 17/00

(52) U.S. Cl. 700/231; 221/92

(57) ABSTRACT

An automatic prescription pill dispensing unit uses a cartridge in which prescription drugs are pre-loaded, preferably by a pharmacist, according to the user's medication regimen. This tamper-proof cartridge can only be unlocked by a pharmacist using a specially designed loading dock, or by inserting the cartridge into the user's dispensing unit. This cartridge approach not only simplifies the loading of the dispensing unit but, more importantly, removes from the caregiver the responsibility of having to handle prescription drugs. The cartridge approach also reduces the footprint size of the original dispensing unit by about 50%. The cartridges can dispense pills up to four times a day for 7 days, and the unit can hold pills from two cartridges, giving 14 days of medication.

### CROSS-REFERENCE TO RELATED APPLICATIONS

This application claims priority from Canadian patent application No. 2,498,496, filed Feb. 17, 2005 and Canadian patent application No. ______, filed Nov. 7, 2005, the contents of both of which are incorporated herein by reference.

### FIELD OF THE INVENTION

The present invention relates to an automatic prescription pill dispersing system and method for controlling the prescription drug regimen of an individual, especially in his/her home, and to a dispensing unit and a cartridge for use therein.

### BACKGROUND OF THE INVENTION

The need for an Automatic Prescription Pill Dispensing System for the ill or elderly has been well documented in the teachings. Numerous novel approaches have been advanced. Large, complex and costly systems have been devised to meet the needs of an institution type environment, namely hospitals and nursing homes. Improved apparatus for home use was the subject of my Canadian Patent No. 2,217,220, granted May 2001, which is further described below.

### PRIOR ART

A number of types of pill cartridges exist in the market. They may be small soft plastic cells with snap down lids. They come in a variety of configurations ranging from a one cell device that holds a number of pills for once a day, all the way up to seven day devices for once a day, to seven day devices for twice a day, to more recently, a seven day, four times a day version (twenty eight cell device); some such 28 cell devices are sold under the trademark “Dosett”, An example of a twenty-eight cell device is shown in U.S. Pat. No. 6,779,663, issued August 24 to Pocsi. There are a few wind-up types with audio indicators that dispense a number of pills 2-3 times a day. I do not know of any cartridges on the market that are tamper proof. Reference however is made to the prior art listed in my aforesaid Canadian patent, which listing includes U.S. Pat. No. 4,911,327 to Shepherd et al., which shows a pill tray of the rotary type which is lockable. Although rotary pill trays are commonly used in the more complex type of pill dispensing devices, they are not suitable for my apparatus. Other lockable receptacles for medicines are shown, for example, in the following U.S. patents:

U.S. Pat. No. 6,338,007 issued Jan. 8, 2002 to Broadfield et al.; and

U.S. Pat. No. 5,190,185, issued Mar. 2, 1993 to Blechl.

Also, U.S. Pat. No. 4,763,810, issued Aug. 16, 1988 to Christiansen, shows apparatus which has a pill-containing receptacle with a slide-open bottom, and which is removable manually when the receptacle is inserted into the apparatus. The apparatus is stated to be tamper-proof, but this refers to a lockable lid for the apparatus and not to the receptacle.

None of the prior art devices, to my knowledge, address all the needs of people requiring medication in their own homes. The need to focus on this application is becoming more apparent as the trend continues towards home care and away from institutional care. A device that meets all the requirements for home use should have at least some, and preferably most, of the characteristics listed below:

The ability to reliably dispense a plurality of types, sizes and number of pills at a plurality of predetermined time intervals.

The ability to dispense prescription drugs for seven days or optionally fourteen days.

The ability to alert the user by visual and/or audible means when predetermined time intervals occur.

The ability to not alert the user at times when there are no pills to be dispensed.

Provide the capability for the removal of pills from the accessible part of the unit to a user inaccessible storage bin if the user does not retrieve the pills within a reasonable waiting period.

Provide access to one day's supply of medication, in the event that the user is away from the dispenser for a part of the day or if the system is waiting repair, with the appropriate safeguards.

To transport the user's medications, from pharmacy to user's residence, using a specifically designed, tamper proof, seven-day cartridge, which is preferably filled by a pharmacist.

Incorporate a seven-day cartridge which can be safely, easily and quickly loaded into the dispenser by a family member or caregiver.

Relieve the caregiver from having to handle prescription pills.

Provide a Help Me capability through which the user can summon a quick response simply by pressing a button on a pendant or bracelet.

Give extensive attention to safety mechanisms and ease of use procedures in keeping with the fact that this Automatic Prescription Pill Dispensing System is for home use and is operating outside the control of an institution and trained medical staff; i.e. no special skills are required for using or setting up the dispenser.

Provide a remote reporting system. (This invention supports seven call types).

Telephone line seizure capability even if line is off hook.

External control of a failed system to remove user pills before the system is removed from the user's residence.

The preferred embodiment of this invention meets all these characteristics.

The present invention describes improvements over the “Automatic Prescription Pill Dispensing System ” described in my aforesaid Canadian patent 2,217,220 granted May 2001, and particularly improvements which make it more safe, secure and operator friendly. The apparatus described in that patent automatically dispenses pills, up to four times a day, to one user in the user's residence. The apparatus needs to be filled every 7 to 14 days, this being done by means of pill holding cartridges, shown in FIGS. 8A, 8B, and 8C of that patent, which are used to supply pills to a pill-holding array which has several rows of pill-holding cells with 14 cells in each row. In the patented device the pills are applied in a separate operation to each of four rows, so that some manual care and knowledge was required to apply pills correctly even assuming that the cartridges themselves were loaded correctly. In view of feedback from users following marketing of that product, numerous enhancements were made in order to develop the present “Cartridge Loaded Automatic Prescription Pill Dispensing System” described herein. These enhancements will be presented in detail in the following sections.

### SUMMARY OF THE INVENTION

Distributors and caregivers continued to have concerns about manually loading pills into the dispenser using the type of cartridges shown in my prior patent. For this reason the present invention makes use of a cartridge or magazine of pills, hereinafter referred to as a “cartridge”, which is different from that of my prior patent in that it can be inserted directly into the pill dispenser in a simple and “fool-proof” manner, not requiring special knowledge or manual dexterity. The cartridge may be filled by a professional, such as a pharmacist, or by a caregiver, and is preferably locked and tamper-proof, being automatically unlocked when placed in the dispenser.

The cartridge may have a rectangular array of pill-holding cells sufficient for at least a 7-day supply of pills. The array preferably includes four cells for each day, to provide for users who need to take pills four times a day.

The present invention provides a cartridge-loaded automatic prescription pill dispensing system designed for controlling the prescription drug regimen of an individual, especially for use in his/her home. The dispensing system may form the basis for a dispenser suitable for a nursing home if modified so that it can be personalized in such manner as to be accessible only by a user with the right key or code.

Embodiments of the invention may dispense a plurality of types, sizes and quantity of pills, preferably at four selected time periods throughout a day, and repeat this sequence for seven, or preferably fourteen days, as predetermined by the user's medication regime.

In accordance with one aspect of the invention, an automatic prescription pill dispensing system comprises, in combination, a dispensing unit and a removable cartridge, the removable cartridge comprising:

a rectangular, normally horizontal upper array of cells for holding pills to be loaded into the dispensing unit, each of the cells having an open bottom closable by sliding bottom panel means, the sliding bottom panel means being able to slide between a closed position such that pills in the cells are prevented from falling through the cells, and an open position such that pills fall from the bottoms of the cells, and the dispensing unit comprising:

a rectangular lower array of cells corresponding to the upper cell array of the cartridge, said lower cells being adapted for holding pills to be dispensed, each of the lower cells being open at the top to permit pills to fall into the lower cells from the cartridge when the cartridge is installed over the lower cell array and when said sliding bottom panel means is open;

the dispensing unit including powered means for moving the sliding bottom panel means of the removable cartridge when the cartridge is installed over the lower cell array to open the sliding panel means and to permit pills in the cartridge to fall into the lower cell array; and

a plurality of array slider a means located under the lower cell array to act as a pill-retaining floor for the pill-holding cells of the lower cell array when in a fully closed position, the slider means being selectively movable predetermined distances from a closed position to several different open positions to permit pills from a desired pill-holding cell of the lower cell array to drop into a pre-dispensing location.

The dispensing unit further comprises:

array slider movement means associated with each of the array slider means for selectively moving each of the array slider means predetermined distances between said closed and open positions;

user-operable dispenser means to cause movement of pills from the pre-dispensing location to a dispensing location where they may be accessed by the user; and microprocessor means for controlling the movement of the array slider means to permit dispensing of pills.

With this arrangement, pills to be dispensed may be loaded into the removable cartridge, for example at a pharmacy, the cartridge being then installed in the dispensing unit in order to transfer the pills to be dispensed from the upper cell array of the cartridge into the lower cell array of the dispensing unit, and pills to be dispensed may then be moved at appropriate time intervals from the lower cell array to the pre-dispensing location.

The cartridge may have a fixed clear cover over the tops of the upper pill-retaining cells when the cartridge is in its normal horizontal orientation, the cartridge being adapted for filling with pills when removed from the unit and inverted, and when the bottom panel means has been slid open.

The microprocessor means preferably also controls movement of the sliding bottom panel means of the cartridge, which may comprise one or two panels; one panel being preferred. In this case an initial supply of pills may be loaded into the cartridge, and then transferred from the upper cell array into the lower cell array in an initial operation, whereupon the cartridge may be removed and replaced with a cartridge filled with a second supply of pills, and the microprocessor then controls the sliding bottom panel means of the cartridge so that the second supply of pills is only released from the cartridge into the lower cell array when the initial supply of pills in the lower cell array has been exhausted. The initial supply of pills will usually be for seven days; the cartridge and the lower pill-holding array each having seven rows of pills, one row for each day. The second supply thus allows the dispensing unit to be filled with enough pills for 14 days; the “double-deck” arrangement of pill cells means that the apparatus requires much less space than that of my Canadian patent 2,217,220, where the pill-holding array had 14 rows; specifically this feature has resulted in a dispensing unit in which the area of the cell array is about half the size of my earlier patented dispenser.

The fourteen day mode of operation can be increased, without repeating the reload procedure, by inserting a third cartridge after the second cartridge had transferred its pills and before the second cartridge reaches the seventh day. This feature does not apply to a seven day mode of operation. The choice of two time intervals for every time period provides flexibility to the user to fit with his/her life style.

The powered means in the dispensing unit for moving the bottom panel means of the cartridge may include an electrically powered, rectilinearly movable carriage that is connectible selectively either to the bottom panel means of the cartridge or to the array slider means. Preferably, the electrically powered carriage has electromagnets, the energization of which is controlled by the microprocessor, and the bottom panel means of the cartridge and the array slider means have couplers that include ferromagnetic elements adapted to be moved by these electromagnets when the latter are energized.

Preferably the cartridge has locking means for the bottom panel means that normally prevent the bottom panel means from being opened when the cartridge is outside the dispensing unit, the dispensing unit having means for automatically releasing the locking means when the cartridge is placed in the dispensing unit. In this case the apparatus combination also includes a docking station, for use by a pharmacist or other operator when the cartridge is being charged with pills and which also has means for releasing the locking means. The locking means may include a magnetically operated latch connecting the upper pill-holding cell array of the cartridge to the bottom panel means, and the dispensing unit and the docking station both have magnets for releasing these magnetic latches.

According to a second aspect of the invention, there is provided a method for automatically dispensing prescription pills using a combination of a dispensing unit and a removable cartridge, comprising the steps of:

placing a supply of pills into the cartridge, the cartridge having a rectangular, normally horizontal upper array of pill-retaining cells, in which each of the cells has an open bottom closable by sliding bottom panel means, the sliding bottom panel means being able to slide between a closed position such that pills in the cells are prevented from falling through the cells, and an open position such that pills fall from the bottoms of the cells,

placing the cartridge into the dispensing unit, the unit having a lower rectangular array of pill-retaining cells corresponding to the upper pill-holding cell array of the cartridge, the lower pill-retaining cells being adapted for retaining pills to be dispensed,

energizing powered means in said dispensing unit to open the sliding bottom panel means to permit pills to fall into the lower pill-retaining cells from the cartridge;

initiating powered movement of a plurality of array slider means located under the lower cell array, the slider means being selectively moved by predetermined distances from a closed position to several different open positions on a predetermined schedule controlled by microprocessor means, to permit pills from a desired pill-retaining cell of the lower pill-holding array to drop into a pre-dispensing location, and

initiating user-operable dispenser means to cause movement of pills from the pre-dispensing location to a dispensing location where they may be accessed by the user.

Either or both of visual and audible alert mechanisms may be used to signal the presence of pills. Also, the dispensing unit may be enable to allow the user access to an illuminated eject button mounted on the front panel.

As a safety feature, embodiments of this invention may remove pills from the active part of the device and place them in the inactive catch bin part of the device, if not accessed after a twenty eight minute waiting period. This prevents possible overdosing. The pills in the catch bin can be retrieved at the next reloading, sorted and reused if positively identified, or otherwise disposed of.

This cartridge approach to medication delivery greatly improves the reliability of pill handling by caregivers of the elderly who want to remain in their residences. The caregiver has the cartridge(s) filled by a pharmacist or other operator, as is traditionally done with pill bottles, and returns the cartridge(s) to the user's residence where it (they) are easily inserted into the pill dispensing unit. The caregiver sets a few controls to tailor the system to the user's life style, closes and locks the lid. The dispenser is set to automatically deliver prescription pills four times a day for fourteen days or seven days.

This dispenser resolves the issue of supplying medication to the user in the instances when the user is away from the dispenser for part of a day or for that period of time that the main dispenser is waiting for repair, should it fail. This is achieved by a portable automatic dispenser referred to in this document as a “Day Away”. This device supplies one day's allotment of critical medicine as prescribed

This invention supports an automatic reload function which is activated when the operator initiates the reload button. This action occurs when it is time to reload the dispenser with a filled cartridge. The function is detailed in a later section.

Often changes from the dispenser of my aforesaid Canadian patent are:

1. The eject mechanism was changed from a pull tab operation in the earlier patented device to an automatic system activated by pushing an eject button in the present invention.

2. The removal of the On Demand function present in my aforesaid Canadian patent. This feature allowed the user to access non-prescription types of pills, at any time, as opposed to prescription pills at specific time intervals. The On Demand feature evolved with so many safety conditions, that its value as an on demand feature was eroded. The advantages of its removal far out weighted its value as a feature as shown below:

The elimination of four on demand rows, allowed the cells in the four remaining rows to be double in size, allowing for a larger number of larger pills as well as the elimination of the possibility of pill hang up. This could be done without having to increase the overall size of the dispenser.

Reliability is increased through the reduction of mechanical parts and control circuitry. A substantial cost saving is realized.

3. A further enhancement involved the removal of the user code setup procedure and replaced it with a unit code. Both serve the same function. This code allows the operator to identify a particular user's call, on their pager, from the many users that the pager is serving. The change was made to eliminate a setup task and reduce hardware. The unit code is a simple software change. Now, instead of setting a user code when a system is installed, each dispenser comes with its own identification number.

The additional enhancement involved re-partitioning of hardware and software to improve accessibility for assembly, testing and repair.

4. A further change was that I wanted to add an emergency call capability, which I term “Help Me”.

All these features culminated in a preferred embodiment of the “Cartridge-Loaded Automatic Prescription Pill Dispenser” of the present invention.

Embodiments of this invention may contain a number of safety features including a remote fault reporting mechanism that, through a paging system, automatically informs the carrier of the pager of the user and the dispenser's status.

Embodiments of this invention may also support a “Help Me” capability which allows the user to send a call for help by pushing a button on a pendant or bracelet. A Code 1 is sent to the operator via the pager.

According to a third aspect of this invention, there is provided a removable cartridge for use with a dispensing unit of an automatic prescription pill dispensing system, the cartridge comprising a rectangular, normally horizontal upper array of pill-retaining cells for holding pills to be loaded into the dispensing unit, each of the cells having an open bottom closable by sliding bottom panel means, said sliding bottom panel means being able to slide between a closed position such that pills in the cells are prevented from falling through the cells, and an open position such that pills fall from the bottoms of the cells; the dispensing unit comprising a lower rectangular array of pill-retaining cells corresponding to the upper pill-holding cell array of the cartridge, said lower pill-retaining cells being adapted for retaining pills to be dispensed, each of the lower pill-retaining cells being open at the top to permit pills to fall into the lower pill retaining cells from the cartridge when the cartridge is installed over the lower cell array and when said sliding bottom panels means is open; said sliding bottom panel means of the removable cartridge being operable by powered means of the dispensing unit when the cartridge is installed over the lower cell array to open the sliding panel means and to permit pills in the cartridge to fall into the lower cell array.

According to a fourth aspect of this invention, there is provided a dispensing unit for use in an automatic pill dispensing system in combination with a removable cartridge having a rectangular, normally horizontal upper array of pill retaining cells for holding pills to be loaded into the dispensing unit, each of the cells having an open bottom closable by sliding bottom panel means, said sliding bottom panel means being able to slide between a closed position such that pills in the cells are prevented from falling through the cells, and an open position such that pills fall from the bottoms of the cells, the dispensing unit comprising:

a lower rectangular array of pill-retaining cells corresponding to the upper pill-holding cell array of the cartridge, said lower pill-retaining cells being adapted for retaining pills to be dispensed, each of the lower pill-retaining cells being open at the top to permit pills to fall into the lower pill-retaining cells from the cartridge when the cartridge is installed over the lower cell array and when said sliding bottom panels means is open;

powered means for moving the sliding bottom panel means of the removable cartridge when the cartridge is installed over the lower cell array to open the sliding panel means and to permit pills in the cartridge to fall into the lower cell array;

a plurality of array slider means located under the lower cell array to act as a pill-retaining floor for the pill-retaining cells of the lower cell array when in a fully closed position, said slider mans being selectively movable predetermined distances from a closed position to several different open positions to permit pills from a desired pill-retaining cell of the lower cell array to drop into a pre-dispensing location;

array slider movement means associated with each of the array slider means for selectively moving each of the array slider means predetermined distances between said closed and open positions;

user-operable dispenser means to cause movement of pills from the pre-dispensing location to a dispensing location where they may be accessed by the user; and

microprocessor means for controlling the movement of the array slider means to permit dispensing of pills;

whereby pills to be dispensed may be loaded into the removable cartridge, which is then installed in the dispensing unit in order to transfer the pills to be dispensed from the upper cell array of the cartridge into the lower cell array of the dispensing unit, and pills to be dispensed may then be moved at an appropriate time from the lower cell array to the pre-dispensing location.

To summarize, a goal of this invention is to develop a “Cartridge Loaded Automatic Prescription Pill Dispensing System” that meets substantially all of the practical pill dispensing needs of the user and caregiver. It should be easy and safe to load, easy to operate, flexible, incorporate a comprehensive safety capability and be economical. I believe that embodiments of this invention achieve this goal.

### BRIEF DESCRIPTION OF THE DRAWINGS

An embodiment of the present invention will now be described, by way of example, with reference to the accompanying drawings, in which:

FIG. 1 is an ISO perspective of the external appearance of the dispenser;

FIG. 2 is a ISO, partly exploded view of the dispenser with a vertical access slider raised, and with the cartridge and lower cell array partly removed;

FIG. 3 is a front sectional elevation of the dispenser frame showing the stack of pill dispensing modules, the slider movement and drive mechanism, and related parts;

FIG. 4A is an ISO perspective of the preferred embodiment of the external features of a locked twenty eight cell prescription pill cartridge;

FIG. 4B is an ISO perspective of a cartridge panel-to-cartridge coupler;

FIG. 5A is a ISO perspective of the cartridge with covers removed to view the locking mechanism;

FIG. 5B is an ISO perspective of the locking mechanism parts, using a leaf spring;

FIG. 6 is an illustration of a cartridge locking and coupler mechanism using a coil spring in place of the leaf spring of FIG. 5B;

FIG. 7A is an ISO perspective of the lower cell array;

FIG. 7B is a detail view of a part of the cartridge locking mechanism carried by the lower cell array;

FIG. 8A is an ISO perspective of the array slider carrier with 4 array sliders with carriage couplers;

FIG. 8B is an ISO perspective of the array slider carried with sliders removed;

FIG. 8C is a side view of an array slider with coupler;

FIG. 9A is an ISO perspective of the right and left remove sliders with couplers;

FIG. 9B is an ISO perspective of the right and left eject sliders with couplers;

FIG. 10 is an ISO perspective of a delivery unit sub-assembly with remove sliders and eject sliders mounted in place;

FIG. 11 is an ISO perspective of the left side enclosure with top sliding portion in place;

FIG. 12 is a illustration of how a cartridge is inserted/removed into/from the dispenser;

FIG. 13A is an ISO perspective of the pharmacist'docking station;

FIG. 13B is a detail view of the cartridge unlocking means of the docking station;

FIG. 14 is an ISO perspective of the carriage printed circuit board showing the 10 magnetic latches used for a cartridge having two sliding panels, and the optical reader;

FIG. 15 is a view similar to FIG. 14 showing an alternative carriage printed circuit board having 9 magnetic latches used for a cartridge having a single sliding panel;

FIG. 16 is an ISO perspective of the “Day Away”;

FIG. 17A illustrates an alternative pill cartridge having a single sliding panel,

FIG. 17B illustrates a magnetic lock for the alternative pill cartridge of FIG. 17A; and

FIG. 18 is a perspective view of the alternative single sliding panel for the cartridge.

### DETAILED DESCRIPTION OF A PREFERRED EMBODIMENT OF CARTRIDGE-LOADED AUTOMATIC PRESCRIPTION PILL DISPENSING SYSTEM

Canadian Paten No. 2,217,220 granted May 2001 for an “Automatic Prescription Pill Dispensing System” describes a device which dispenses pills at a preset intervals over the course of seven or fourteen days. The present invention describes an improved, cartridge-loaded version of that automatic prescription pill dispensing system.

With the exception of the new cartridge function and the changing of the mechanical means of ejecting pills to an external tray, the general pill dispensing apparatus and the pill transport mechanism are the same as in the '220 patent, and are described below. The following is an overall description of the location, relationship and function of the components that make up this pill dispensing system, and will give the reader a general understanding of the operation of this automatic prescription pill dispensing system. Additional detail will be given on key components and setup procedures below.

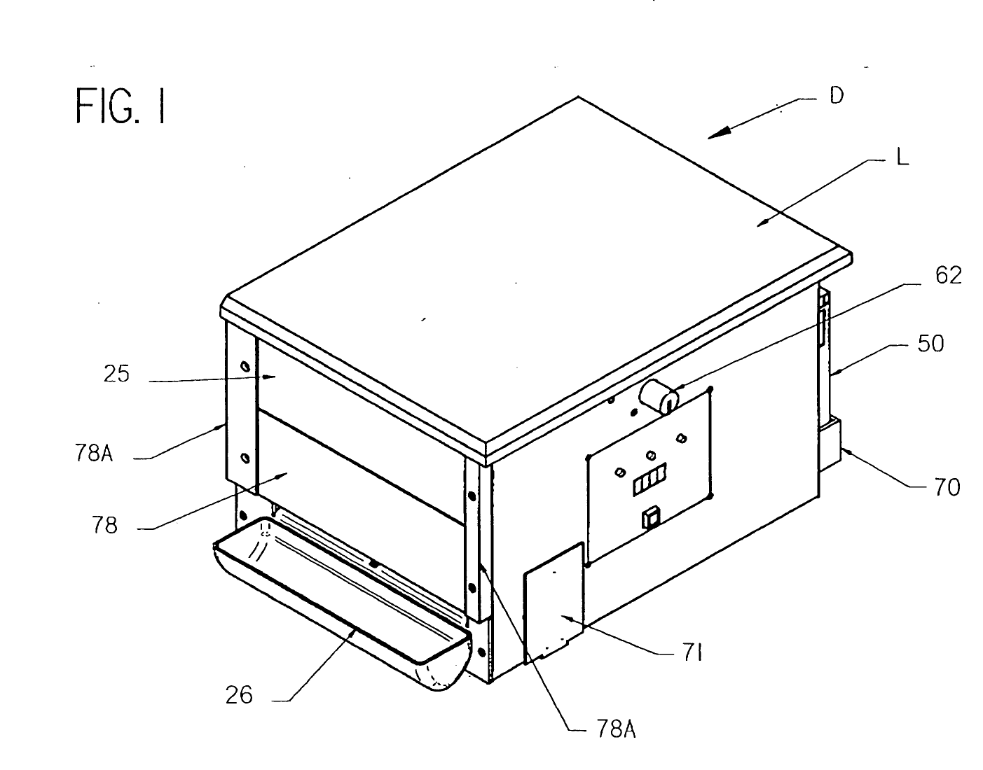

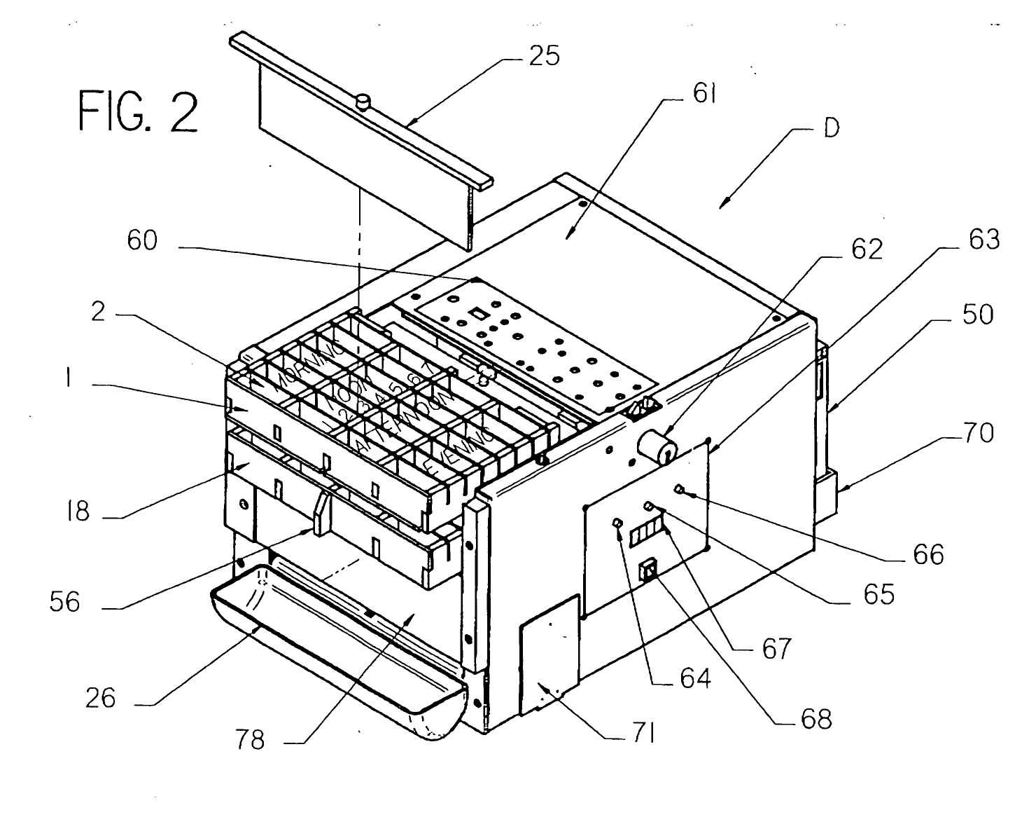

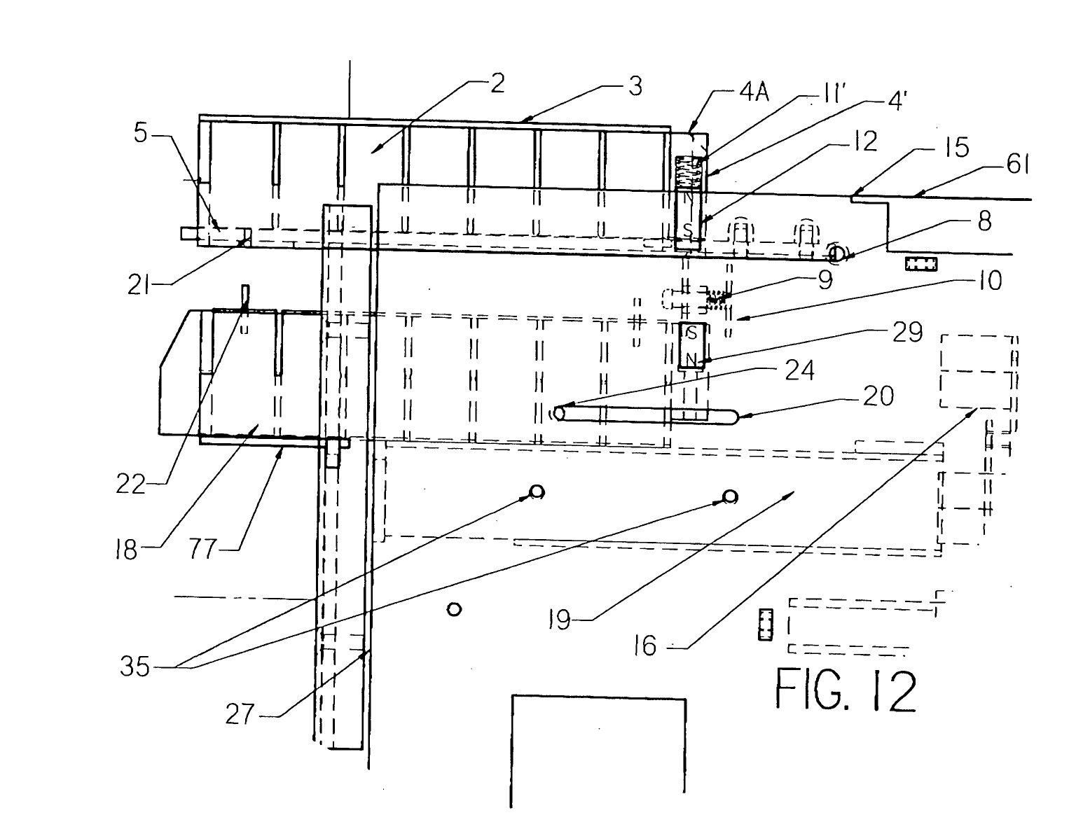

As shown in FIGS. 1 and 2, the dispenser D, in general terms, comprises a cabinet provided with a top lid L which is lockable by means of a lock 62 and which may be opened to allow access to the interior; the lid has been removed in FIG. 2 to show the interior. On the left side is the external tray 26 into which ejected pills fall. On this same side is a removable, vertically sliding panel 25 called the “access slider” which is trapped in place by the lid L when the latter is closed. This slider 25 has its ends slidable in channels 78A extending up from the sides of fixed lower panel 78. When the lid is open, this access slider 25 can be lifted upwards and out, exposing the left end of the cartridge 1 and the lower cell array 18, which sits directly under the cartridge 1. In FIG. 2, this access slider 25 is shown lifted out to expose the left, outer sides of the cartridge 1 and lower cell array 18. Also revealed is tab 56 attached to array 18 which allows the cartridge and cell array combination to be pulled to the left two inches, clearing the cartridge from under the top face place 61. FIG. 12 shows the cartridge being lifted up and out of the dispenser. When the cartridge is in its operating position in the dispenser the top face of the cartridge locking mechanism 4A, as seen in FIG. 12, slides under the leading edge 15 of the top face plate 61; this traps the cartridge in place. Also, the forward position of the cartridge is controlled by the leading edge of the cartridge's plastic cover 3 pressing against the front edge 15 of the face plate 61. FIG. 12 also shows one of the slots 20 on the internal frame 27 in which the lower cell array 18 slides. This lower cell array is free to slide horizontally in slots 20 on the front and back sides of the frame 27, guided by screws 24 fixed to the lower cell array. FIG. 12 shows the front screw 24 up against the end of slot 20 thereby limiting the distance that the lower cell array 18 can be pulled outwards.

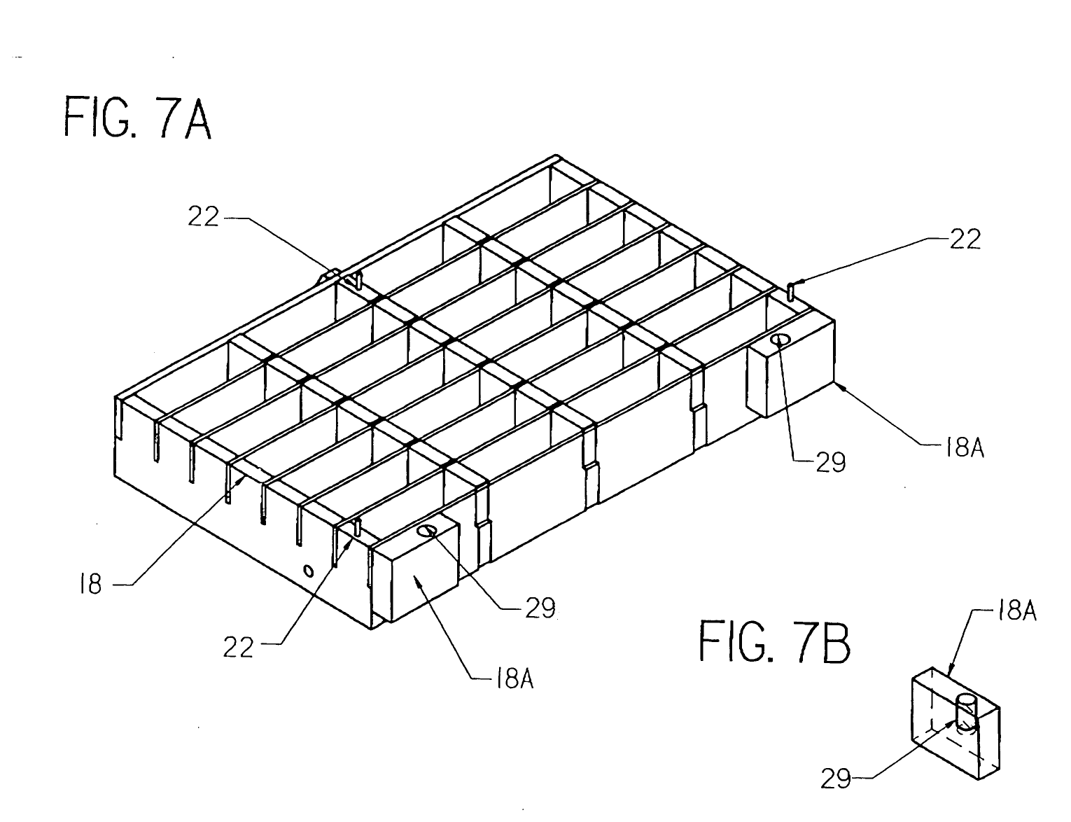

As also indicated in FIG. 12, the cartridge 1 has three holes 21 on its underside, of which only one can be seen in the side view of FIG. 12. These holes mate with three pins 22 mounted on the top of the cell array 18, of which one can be seen in FIG. 12. All three pins 22 can be seen in FIG. 7. This interlocking arrangement holds the cartridge in place directly over the lower cell array 18.

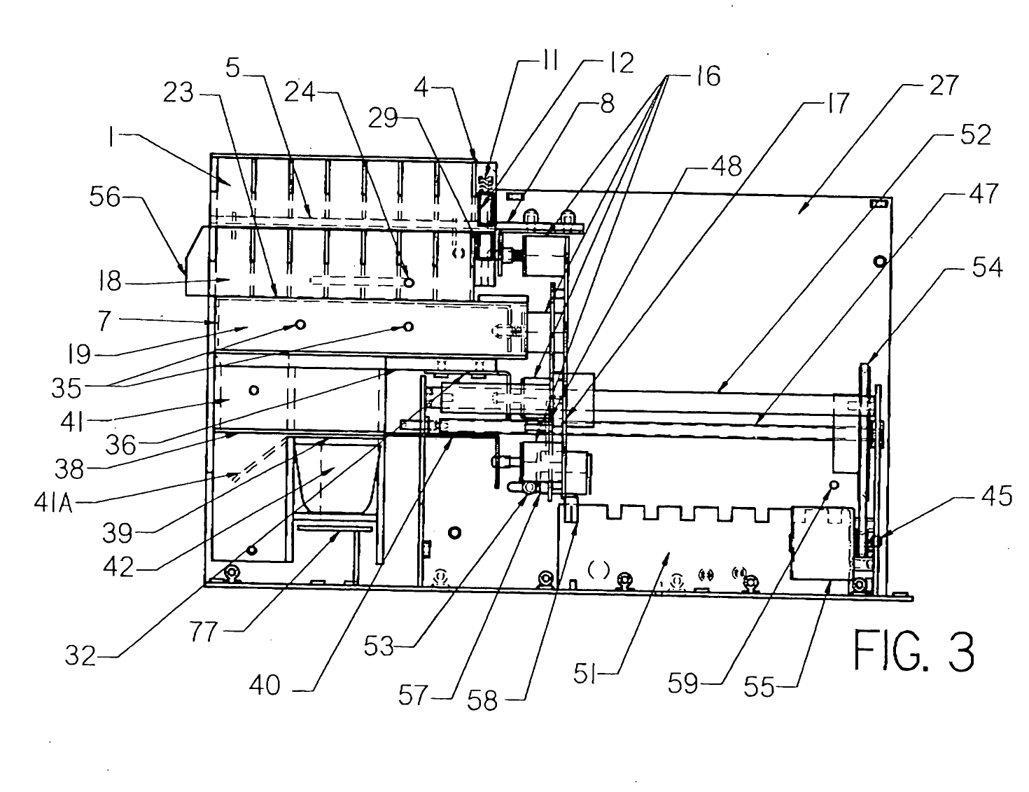

As viewed from the top, in FIG. 2, the cartridge 1 can be seen on the left hand side. The face plate 61 fills the remaining space on the top right hand side. The main control panel 60 and the operating instructions are on this face plate 61. On the lower front of the dispenser, as seen in FIGS. 1 and 2, is an access panel 71 to a catch bin 42 which, as seen in FIG. 3, resides on a shelf in the dispenser D. The catch bin 42 serves as a storage unit for any pills which are not taken by the user within predetermined time limits, thereby removing these pills from further access by the user. The access panel 71 can only be opened when the lid L is open.

Also on the front, as seen in FIG. 2, is the front visual panel 63. This panel has only the visual indicators and control that are necessary to be seen or accessed when the dispenser lid is closed and locked. The indicators are: power 64, phone jack monitor 65, pager off 66, time display 67 and illuminated eject button 68.

Also, seen in FIGS. 1 and 2, on the right hand side of the dispenser is the “Day Away” holder 70 with a “Day Away” unit 50 mounted in it. The system supports two “Day Away” units.

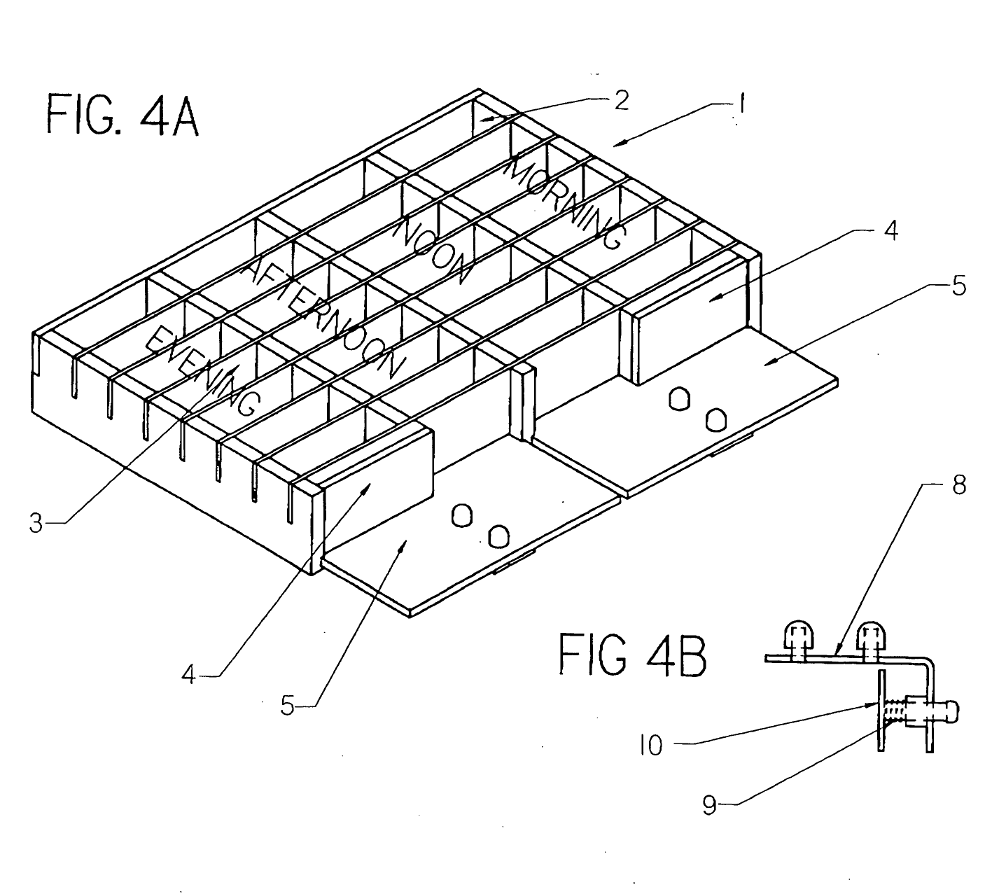

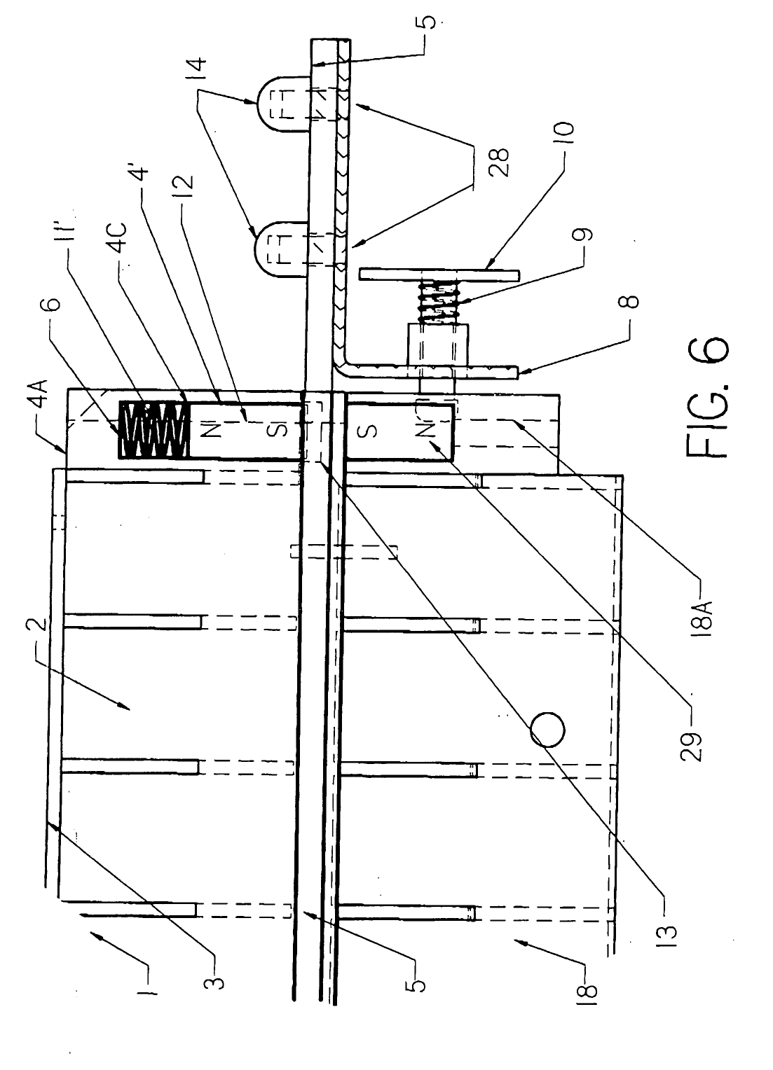

FIG. 4A shows the cartridge 1 which is a rigid rectangular structure made from high impact plastic. In one sample embodiment, the unit is 5.0 inches long, 8.23 inches wide and 1 inch deep. Each cell is 1.77 inches long, 0.612 inches wide and 1.0 inch deep for a volume of 1.08 cubic inches. These sizes were chosen to allow for most medication regimens to be accommodated within any cell. Both the cartridge 1 and the lower cell array 18 have the same geometry and consist of four rows of seven cells to make twenty eight cell device. The top of the cartridge is enclosed by a clear, permanently attached acrylic plastic cover 3 on which the rows are labeled “Morning”, “Noon”, “Afternoon” and “Evening”, and the columns are numbered 1 through 7. The labeling is repeated on the bottom of the cartridge. This labeling aids the pharmacist or caregiver during the filling process, and the caregiver during the setup process. As seen in FIGS. 4A, 5A and 6, the bottom side of the cartridge is enclosed by panel means in the form of two sliding panels 5. Each panel covers two rows and runs the length of the device. These panels are locked in place when the cartridge leaves the pharmacy, and remain locked while outside the dispensing apparatus, being unlocked only when the cartridge is inserted into the pill dispenser, in order to prevent unauthorized access to the pills. The locking mechanism, details of which are given below, provides latches which engage cavities 13 in the panels 5 below. The panels 5 are extended at the rear and are each equipped with a coupler 8, as seen in FIGS. 4D and 6. Each coupler member 8 has an armature 10 made of a ferro-magnetic metal, as shown in FIGS. 4B and 6, such that it may be magnetically held by a electromagnetic latch. The corresponding electromagnetic latches 16 are attached to a printed circuit board 17, as shown in FIGS. 3, 14 and 15, this board being mounted on a movable carriage plate 48; details of this arrangement are give below. The two panels 5 always move in tandem. The ferro-magnetic armatures 10 for these panels, and for other sliding parts to be described below, are resiliently mounted by springs 9 shown in FIG. 6, to ensure that they are in contact with the respective electromagnetic latch 16 when in the rest position, in spite of slight inaccuracies which may occur in fitting of the parts.

Located directly beneath the removable cartridge 1, as shown in FIGS. 2 and 3, is a lower cell array 19 shown separately in FIG. 7, and which consists of a rectangular array of receptacles or cells for holding pills. In the embodiment shown, the lower cell array 18 has the same geometry as the cartridge 1, and each cell of the cell array 18 is aligned with the corresponding cell of cartridge 1 above. Therefore, when the cartridge 1 transfers pills to the cell array 18 below, the pills in each cell in the cartridge are transferred to the corresponding cell in the lower cell array. The seven day's supply of pills reside in the cell array 18 until called for.

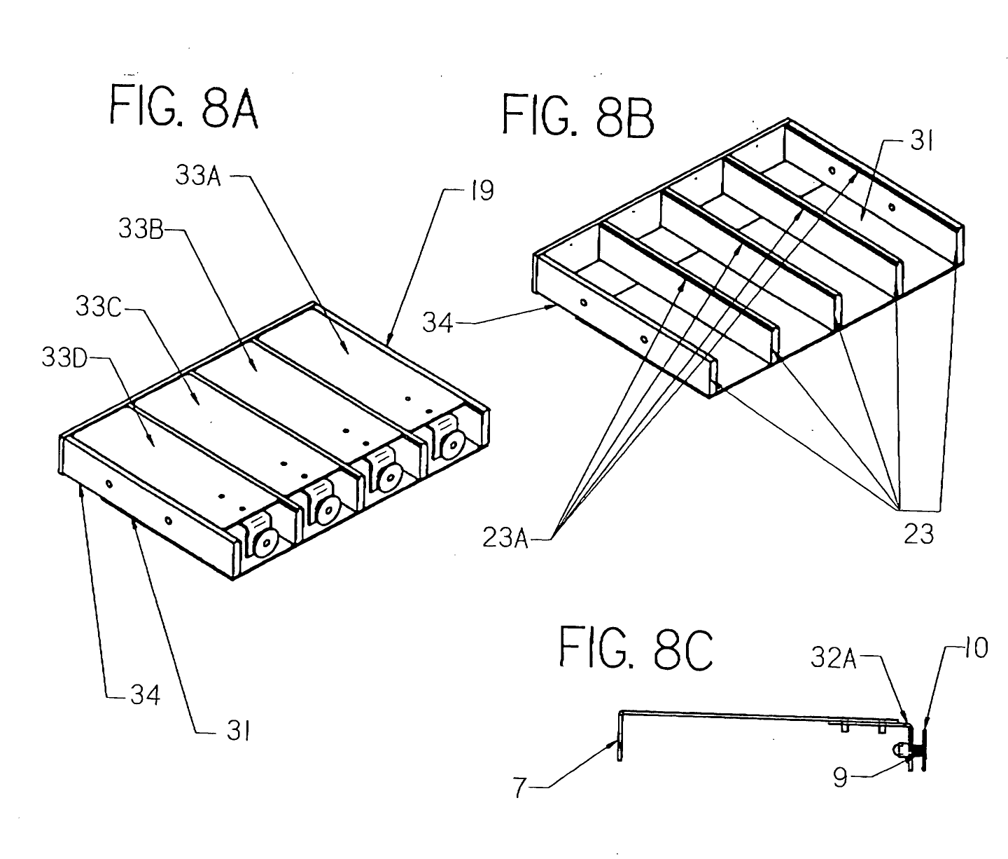

Located directly beneath the lower cell array 18, as seen in FIGS. 3 and 12, is the array slider carried 19. It is fixed to the frame 27 by two screws 35 on each side of the array slider carrier. As seen in FIGS. 8A and 8B, this array slider carrier 19 has a floor 31 which does not cover the entire unit but is spaced from its front end (the left end as seen in these drawings) to provide an opening 34. Five vertical, fore-and-aft wall members 23 are mounted on this floor 31. The top edges of these vertical members 23, as shown in FIG. 8B, have grooves 23A on both sides (of which only one side can be seen) in which array sliders 33A, B, C and D are free to slide; these will be referred to generically as sliders 33. FIG. 8A shows the four horizontal sliders 33 sitting in their grooves. Each slider is located under one of the horizontal rows of cells of the lower cell array 18 above. This slider carrier 19 enables the sliders 33 to be slid back and forth by a carriage mechanism including plate 48, indicated in FIG. 3, and described below. When the sliders 33 are fully closed (to the left as shown in FIG. 8A), any pills in each cell are retained in each cell of array 18 by the sliders which form the bottoms of the cells.

Each array slider 33 is independently capable of being retracted or slid from a fully closed position as shown in which each cell in the row has a bottom, through predetermined distances, up to a fully open position in which none of the cells has a bottom, thereby allowing any pills within any given group of cells to fall downward into or through the array slider carrier. By selecting any one of the four array sliders 33 and controlling the degree of retraction of the slider, any give row of cells may thereby be progressively emptied of its contents.

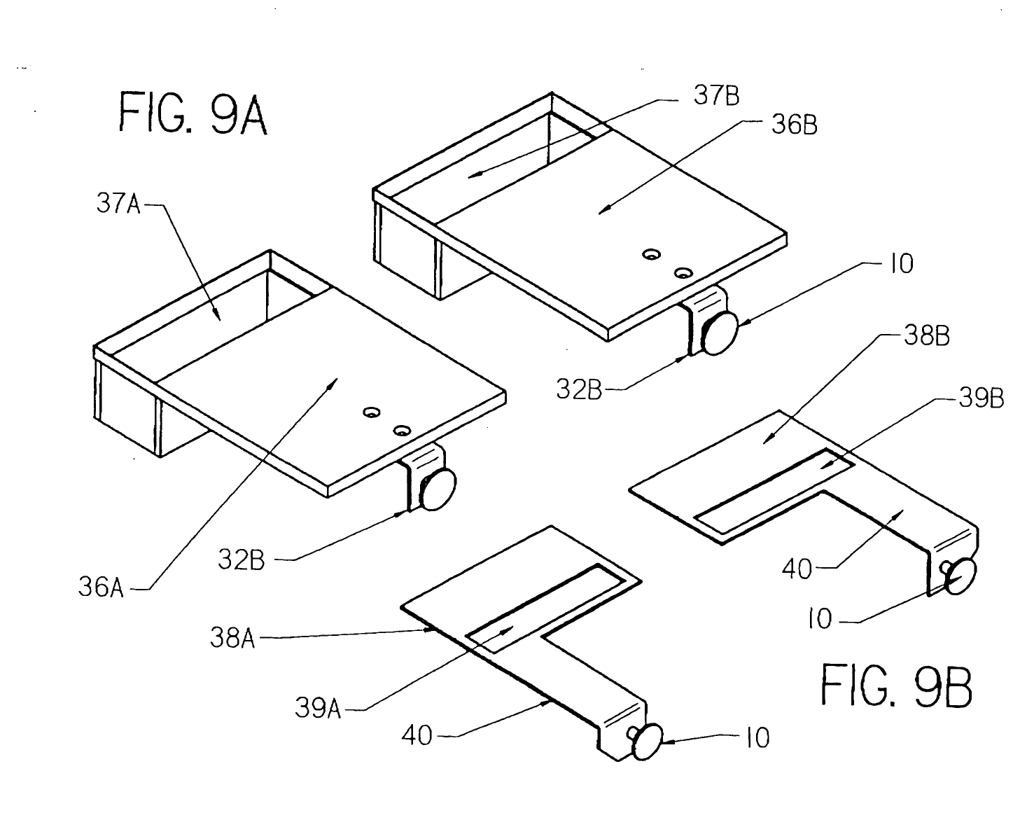

At a front end of each of the array sliders, as shown in FIG. 8C, is a small vertical rectangular member or paddle 7 which projects downward and stops just short of the top surface of the slider carrier floor 31. When a slider is being moved to a fully closed position from a partially opened position, this paddle, in cooperation with the top surface of the slider carrier floor 31 and side wall members 23 protruding upward from the floor on each side of each slider, allows the slider 33 to push forward any pills which have fallen from a cell above, along the surface of the slider carrier floor 31, until they fall through the front opening 34 in the floor 31 and into a remove slider repository area 37A or 37B as shown in FIGS. 3 and 9A.

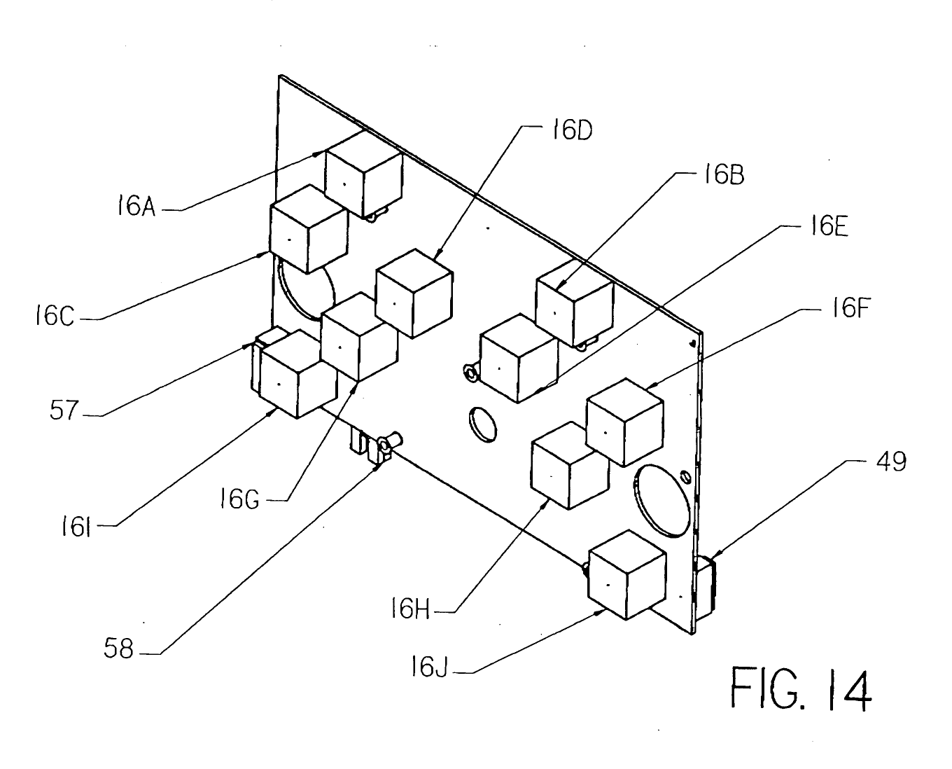

At the end of each of the sliders 33 opposite from the paddle 7 is a coupler 32 having a rectangular member 32A projecting downward. Each coupler member 32A has an armature 10 made of a ferromagnetic material, as shown in FIG. 8C, such that it may be magnetically held by one of the electromagnetic latches attached to the printed circuit board 17, as shown in FIGS. 3 and 14. As indicated above, this printed circuit board 17 is in turn mounted on a movable carriage plate 48 thereby permitting a slider to be retracted to the desired position. As before, the armature 10 is resiliently held by spring 9.

Mounted below the slider carrier 19 are two remove sliders 36A and 36B as seen in FIGS. 3, 9A and 10. These two remove sliders have a combined width equal to the width of the overlying four slider carrier rows, and are similarly equipped with downward projecting couplers 32B whose armatures 10 allow the remove sliders to be retracted. At the outer end of each of these remove sliders are box like structures 37A and 37B having open bottoms; these are referred to herein as repositories. This is where pills are placed in advance of the time they are required. The two remove sliders 36A and 36B always move in tandem.

Below the remove sliders 36A and 36B are eject slider 38A and 38B as seen in FIGS. 3, 9B and 10. The two eject sliders 38A and 38B have the same area as the remove sliders 36A and 36B above them, and the outer or front ends of these eject sliders provide the bottoms of the repositories 37A and 37B of the remove sliders. At the inner ends of the eject sliders are apertures 39A and 39B which are located directly over the catch bin 42 in their closed or forward position. Pills in the repositories 37A and 37B are directed to the external tray 26 is the eject sliders 38A nd 38B are moved two cell positions inwards, i.e. to the right as shown. As will be explained, this movement of the eject sliders is not automatic, but requires input from the user, who indicates intention to take the pills, via the control mechanism for the carriage plate 48 to be described. However, if this movement is not initiated by the user within a delay period of 28 minutes after the time to take the pills has been signaled (by means described below), the remove sliders 36A and 36B move two cell positions to the right, i.e. inwards, and the pills are dumped through the apertures 39A and 39B of the eject sliders into the catch bin 42 below. The two eject sliders 38A and 38B always move in tandem.

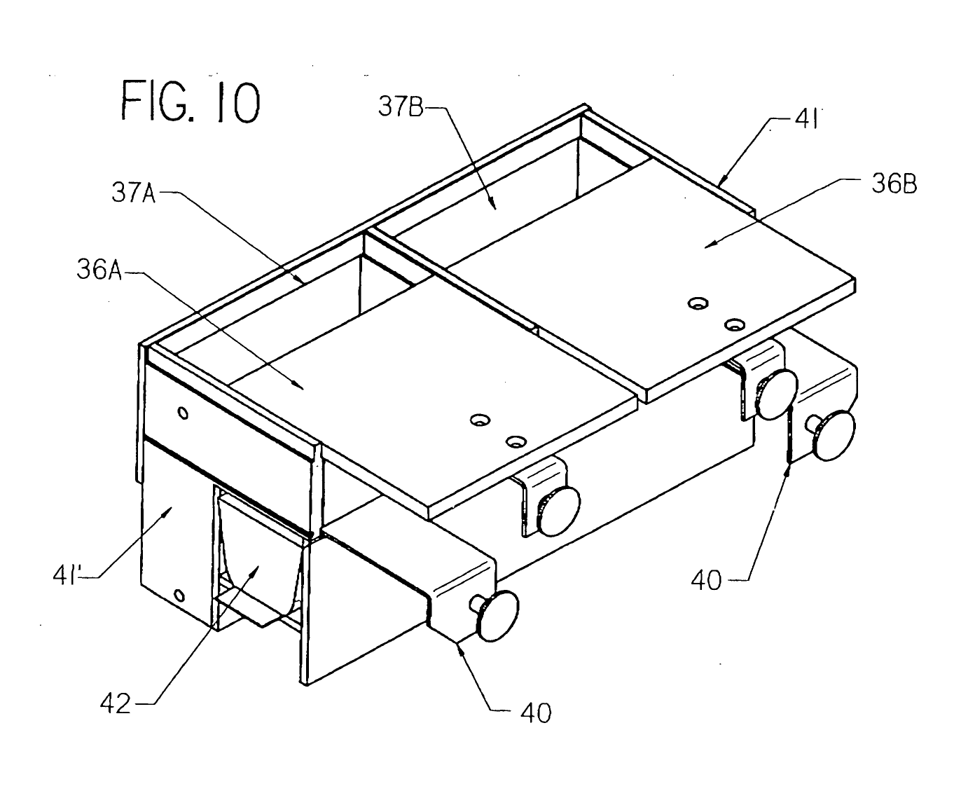

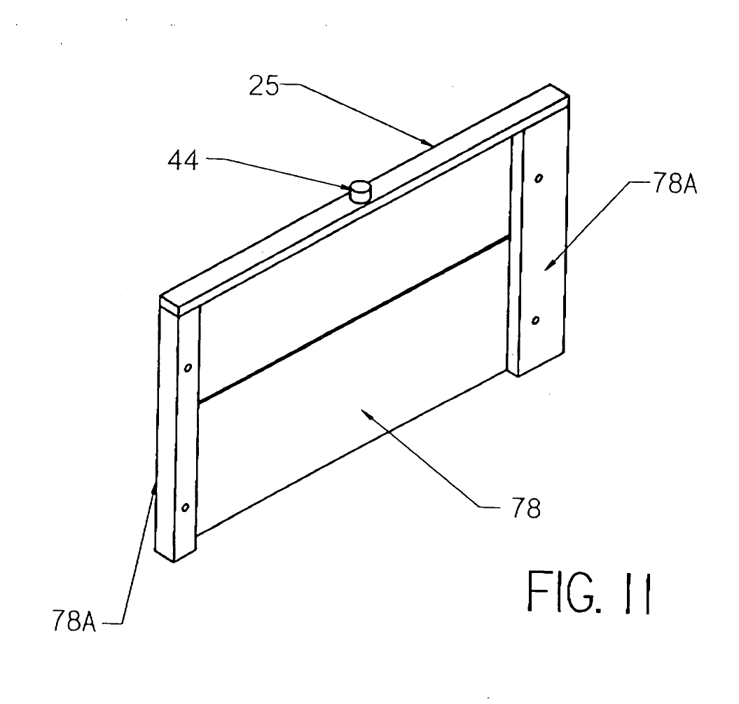

As shown in FIG. 10, the structure that supports the remove sliders and the eject sliders is a sub-assembly called the delivery unit 41. The eject sliders 38A and 38B slide in slots in the walls 41′ of this delivery unit. The remove sliders 36A and 36B slide in grooves on the top members of this unit. In the delivery unit, under the repositories, are two structures 41A that slope downward at 45 degrees. These structures are shown dotted in FIG. 3 since they are behind the walls 41′ of the delivery unit 41. These structures direct pills dropped from the repositories above into the external tray 26 shown in FIGS. 1 and 2.

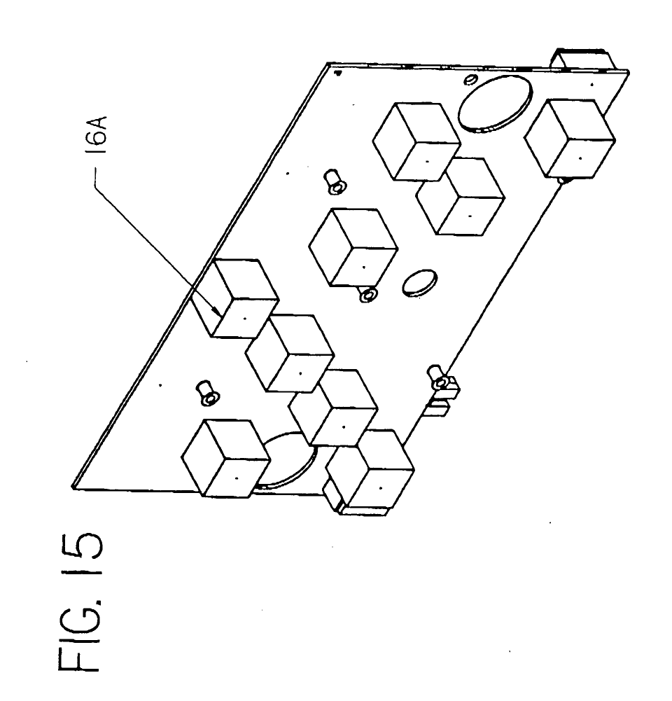

The movable carriage drive mechanism is located below and to the right side, as seen in FIG. 3. It is composed of the carriage plate 48 which rides on two stainless steel rods 52 and is moved to the right and back by an electrically powered lead screw 47 which is attached to the carriage plate 48 by a lead nut. The lead screw is driven from a large pulley 54 connected to a small pulley 45 which is fixed to a 3000 RPM motor 55. The small to large pulley arrangement produces a 5:1 speed reduction and the lead screw has 28:1 turns per inch ratio. Under these conditions and with a cell width of 0.67 inches, the carriage travels a distance of one cell position 2.0 seconds. Mounted on the carriage plate 48 is a printed circuit board 17 called the transport PCB. The ten electromagnetic latches 16 and supporting electronics are mounted on this PCB, as shown in FIGS. 14 and 15. These electromagnetic latches are independently controlled by the micro-controller. Two of these ten latches 16A and 16B are positioned on the transport PCB so as to engage and magnetically hold the two coupler mechanisms 8 of cartridges 1. Four of these ten latches 16C, D, E and F are positioned on the transport PCB so as to engage and magnetically hold the coupler mechanisms 32A of the four array slider carries 33A, B, C and D. Two of these ten latches 16G and 16H are positioned on the transport PCB so as to engage and magnetically hold the coupler mechanisms 32B of the two remove sliders 36A and 36B. Two of these ten latches 16I and 16J are positioned on the transport PCB so as to engage and magnetically hold the two coupler mechanisms 40 of the eject sliders 38A and 38B.

By this means, the micro controller selectively activates any of the four functions purge, transfer cartridge pills, remove or eject, engaging their associated electromagnetic latches 16, causing the carriage to move to the right by the appropriate number of cell positions, retracting the corresponding slider(s) or panels as it moves, and permitting pills to drop to their appropriate location.

For example, for transferring pills from the lower cell array 18 to the repositories 37A and 37B for the next time interval, assume that the morning array carrier slider 33A is magnetically linked to the morning electromagnetic latch 16C by the micro-controller, then the micro-controller commands the carriage plate 48 to move say, six cell positions to the right (sixth day of operation). The pills in the sixth cell are dropped onto the top of the array slider carrier floor 31. The carriage is then reversed by the micro-controller, causing the paddle 7 of the morning array carrier slider 33A to push the pills which have dropped onto slider carrier floor 31 toward the aperture 34 in the floor 31. The pills then drop through this aperture 34 into the repository 37B where they wait to be taken or removed automatically as the case may be. A more detailed description of this operation is given below.

Cell Counting and Positioning of Array Sliders.

Mounted on the base of the dispenser is a positioner 51, as seen in FIG. 3. This device has seen notches where the predetermined distance from the leading edge of one notch to the leading edge of the next notch is the same as the distance from one cell position to the next cell position. Mounted on the transport PCB 17 is an optical device 58 that straddles the positioner 51, as seen in FIG. 14. When the carriage is moving, and the optical device passes over the leading edge of a positioner notch, light passes from one side of the device to the other producing a electrical pulse. The micro=controller records the position of the carriage by counting these pulses. If for example, the carriage was moving in the right pulling the Morning array carrier slider 33A (bound to latch 16C), the slider would have fully uncovered the first Morning cell of the cell array 18 when the first notch on the positioner 51 was detected. If the system was in the first day of operation, the carriage would reverse and go to the home position and turn off. If the system was in the second day of operation, the carriage would go two cell positions, drop the pills in the second cell, reverse and go to the home position and turn off. In the case of the eject and remove functions, the number of cell positions moved are fixed at two positions. In the case of the fill function, the array sliders 33A, B, C and D move one slider at a time, one cell position on the first day of operation. The starting point of a week depends on when the dispenser was loaded. From this point on, it cycles through the four time periods, i.e. Morning, Noon, Afternoon and Evening (eight time intervals) and then jumps to two cell positions. It repeats this sequence through the fourteen days of operation. We will continue now with the dispenser operation.

Cell Array Extender

The cell array extender 77 can be seen in its storage location under the catch bin 42, as shown in FIG. 3. It is an inverted “L” shaped plastic device with a 2 inch top and a 1.5 inch vertical part. It is used when a second or third cartridge is installed.

This device 77 serves as a base for the lower cell array 18 when this loaded cell array is extended outwards two inches, to the position shown in FIG. 12, to allow removal of an empty first cartridge 1 in preparation for installing a second full cartridge. If this device were not installed, the pills in the first two columns of the cell array would fall out. The installation procedure is as follows: With the vertically sliding access slider 25 lifted out, the cell array extender 77 is removed from its storage location under the catch bin 42 via access panel 71, and inserted into slots provided by upper parts of inwardly open channels 78A fixed to the ends off the lower left hand member 78, as shown in FIG. 11. The device fits firmly in these channels, on top of member 78, with its top section projecting outward to the left. Its top surface is flush with the bottom surface of the lower cell array 18 above thereby forming a bottom for the projecting part of the cell array.

Cartridge Advantages

The cartridge 1 is a removable, tamper proof, prescription pill transport device. It is filled by a pharmacist according to the user's prescription drug regimen, delivered to the user's residence and inserted into the Automatic Prescription Pill Dispensing System by a qualified operator. It is this removable cartridge that makes this invention work commercially. The use of a cartridge allows a second week's supply of pills to be stored above a first week's supply, and effectively cuts the footprint area of the overall unit in half, making it more practical. The smaller unit is more attractive to have in the home and is lighter in weight. More importantly, the cartridge may now be filled by a pharmacist, as opposed to a caregiver loading individual pills in the user's home. It remove the responsibility of the caregiver from handling pills. Legally, only family members or qualified persons may handle prescription pills. This way, non-certified people may load the dispenser and in a highly secure fashion. This makes the unit more attractive to distributors because of legal liability issues.

From a distributor's point of view, profit is not only in the leasing of the dispenser to the user, but also in the filling of the cartridge. Therefore, pharmacies that act as distributors of this invention gain both from leasing as well as refilling the cartridge, since the caregiver must go back to the pharmacy that supports the cartridge invention.

A further advantage is that it will reduce costs to the user, since it is advantageous to have many different pill prescriptions filled at once per cartridge at a flat rate, as opposed to charging user dispensing fees per pill prescription. For example, if a user has 10 different pill prescriptions, the user would pay 10 dispensing fees. Instead, pharmacists can afford to make more money by simply charging a flat monthly rate for refilling cartridges.

Note on Coupler

There are 4 types of couplers all performing the same function that being to insure contact of the sliders to the electromagnetic latches. The differences are in the means of mounting the couplers to the sliders. All couplers are composed of the same parts namely a right angle bracket in which is pressed a threadless perm standoff. A ferro-magnetic disk 10 to which a long threaded standoff is pressed. A spring 9 is mounted on the threaded standoff and the armature 10 is inserted into the threadless standoff. The assembly is held together by a screw. This arrangement allows for 0.2 inches of compression which adjusts for manufacturing variations.

Cartridge Panel Locking Mechanism

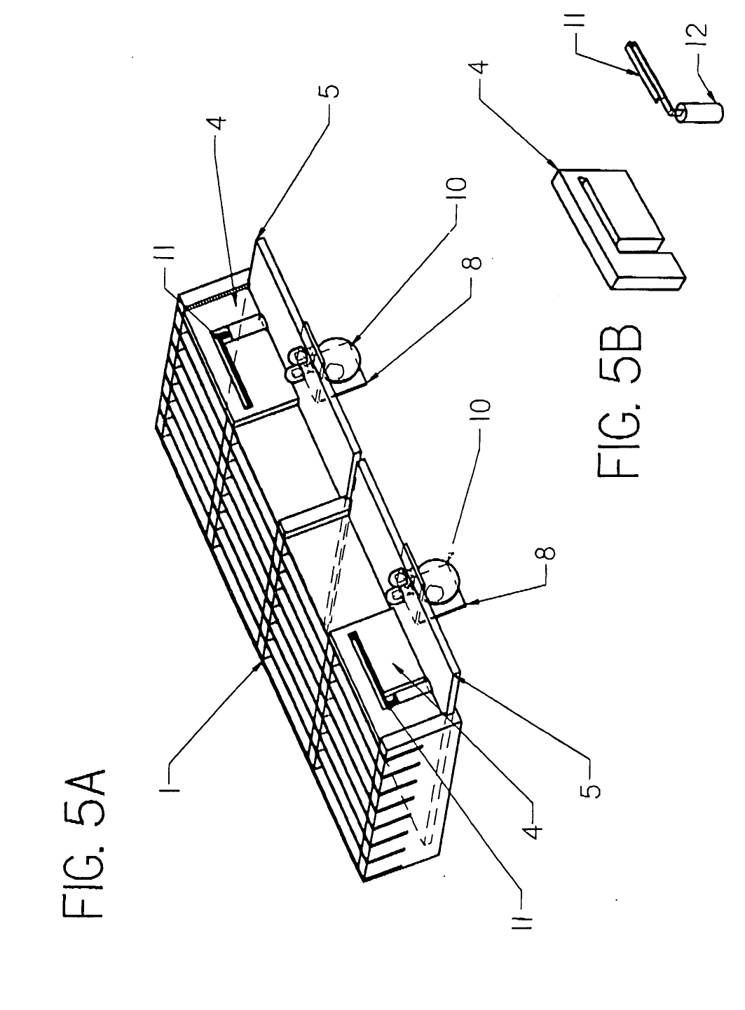

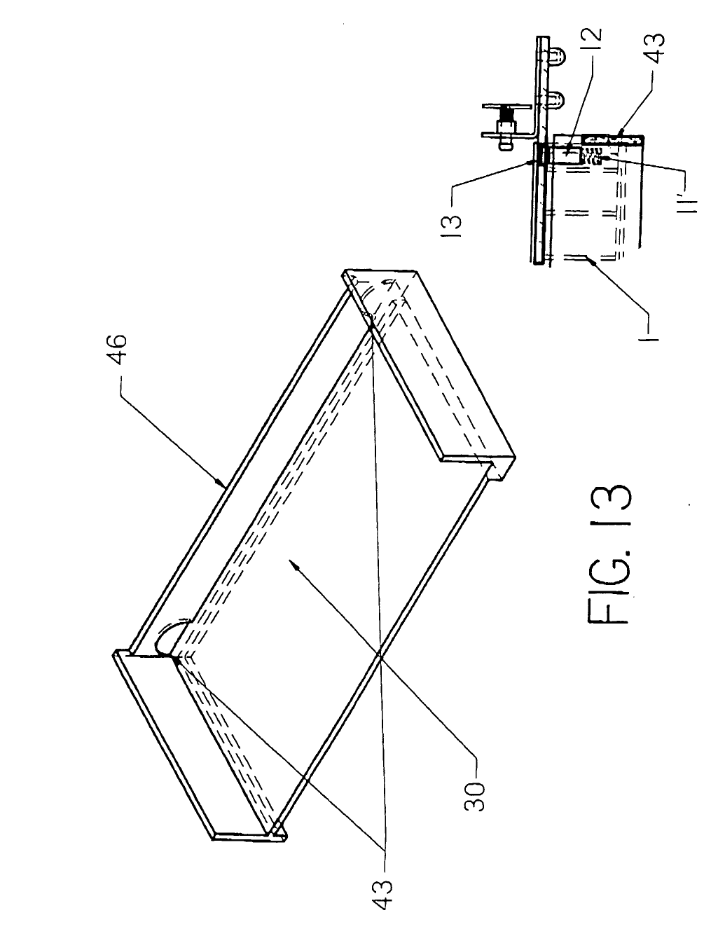

As seen in FIGS. 4A, 5A and 6, on the body of the cartridge 1, or its inner end, are two blocks 4 that house the panel locking mechanism. FIGS. 5A and 5B show one embodiment of the locking mechanism of the cartridge. The cartridge locking blocks 4 have their covers removed in FIG. 5A to show the locking mechanisms. There are two locking mechanisms, one for each sliding panel 5. FIG. 5B is an enlarged view of the block 4 showing the cavity in which the locking spring 11 and the rare earth cartridge magnet 12 sits. In this embodiment the spring 11 is a leaf spring in an elongated U shape, and is composed of a ferrous material, and is fixed in the cavity about the magnet 12 which is held to the spring by magnetic attraction. This spring 11 serves two purposes. First, it prevents the magnet 12 from falling out of the cavity and second, it is adjusted to put a downward force on the magnet forcing it into upwardly open cavity 13 in sliding panel 5, as seen in FIG. 6, thereby locking the panel in place. The panels can only be unlocked by the pharmacist using a docking unit 30, see FIG. 13, which will be described later, or by inserting the cartridge 1 onto the cell array 18.

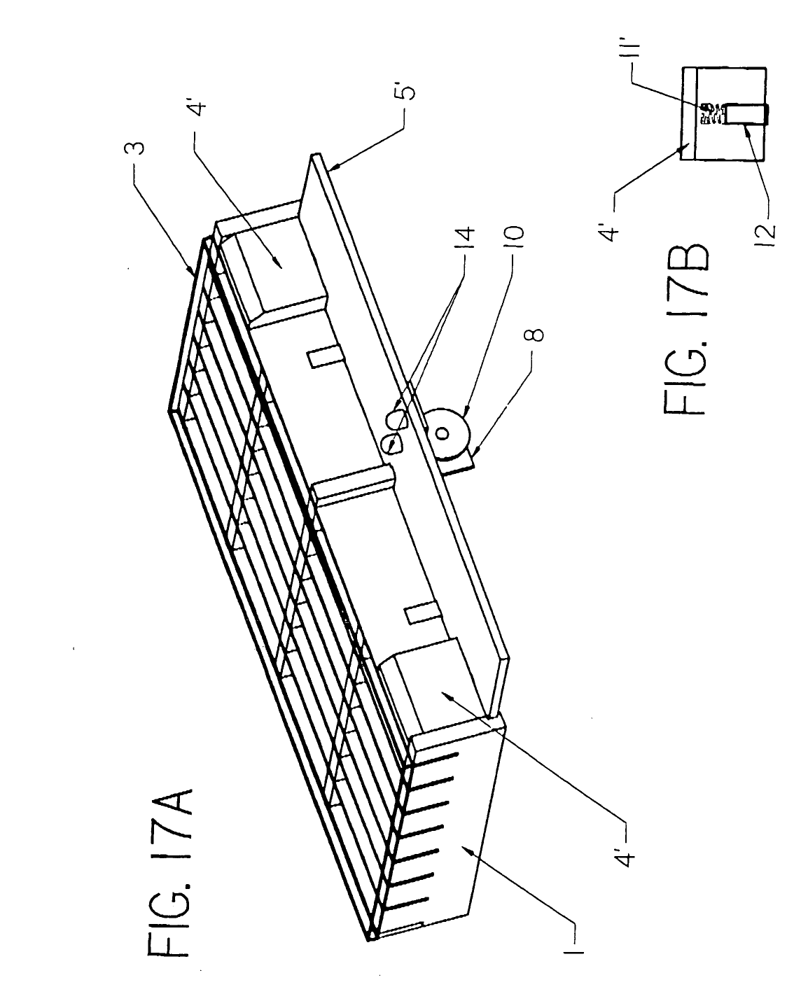

FIG. 6 shows the operation of the locking mechanism. In FIG. 6 the leaf springs 11 have been replaced with helical compression springs 11′, but the operation is the same whichever type of spring is used. The use of a helical spring is further described below with reference to FIGS. 17A and 17B.

The lower cell array 18 has similar magnets 29 on rear extension 18A of the array, as shown in FIGS. 6, 7, and 12, placed directly beneath the cartridge magnets 12. These magnets are oriented with like poles facing each other. When the cartridge 1 is inserted into the dispenser, the opposing magnetic fields force the cartridge magnets 12 to move upward against their springs 11′. This removes the magnets 12 from the sliding cavities 13 of the panels 5, allowing the sliding panels 5 to be removed from the cartridge.

FIG. 6 also shows the connection of coupler brackets 8 in the underside of the rear extensions of each sliding panel 5. Each coupler bracket 8 has a horizontal portion with two upstanding pcm studs 28 which project through holes in the rear extensions of the panels 5, and are fixed in place by dome nuts 14. The couplers 8 are protected in transit by a molded plastic cover (not shown) which can easily be snapped on and off as required.

FIGS. 17A and 17B show front and side views of an alternative, and preferred, magnetic lock that is more economical to make than that of FIGS. 5A and 5B, and which is similar to that of FIG. 6. Here the locking clock 4′ has a straight, vertical bore 4C which receives a helical steel compression spring 11′, which in turn holds a cylindrical magnet 12. The spring 11′ is held adhesively in the bore at point 6 in FIG. 6, and the magnet 12 is held to this by magnetic attraction. As before, the magnet 12 is pushed into the cavity 13 when the cartridge 1 is outside the dispenser, but is pushed upwards by magnet 29 of the lower array when put in place.

Note on Cartridge Sliding Panels

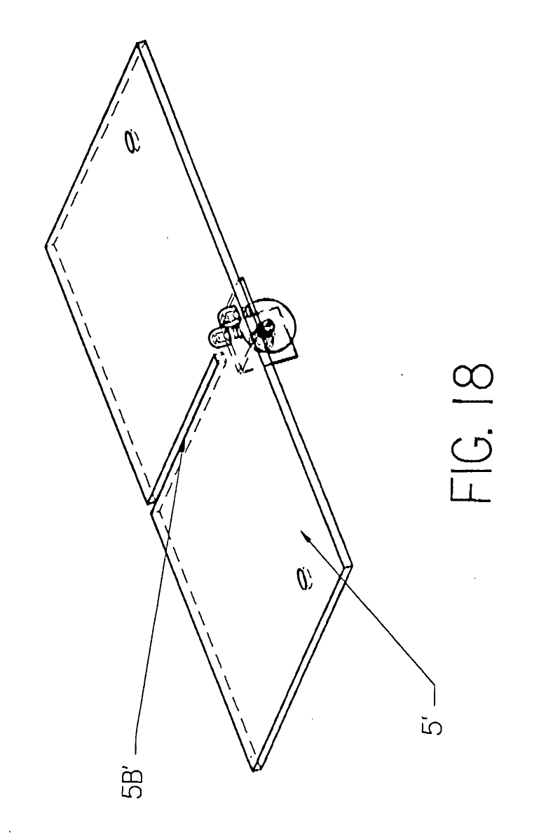

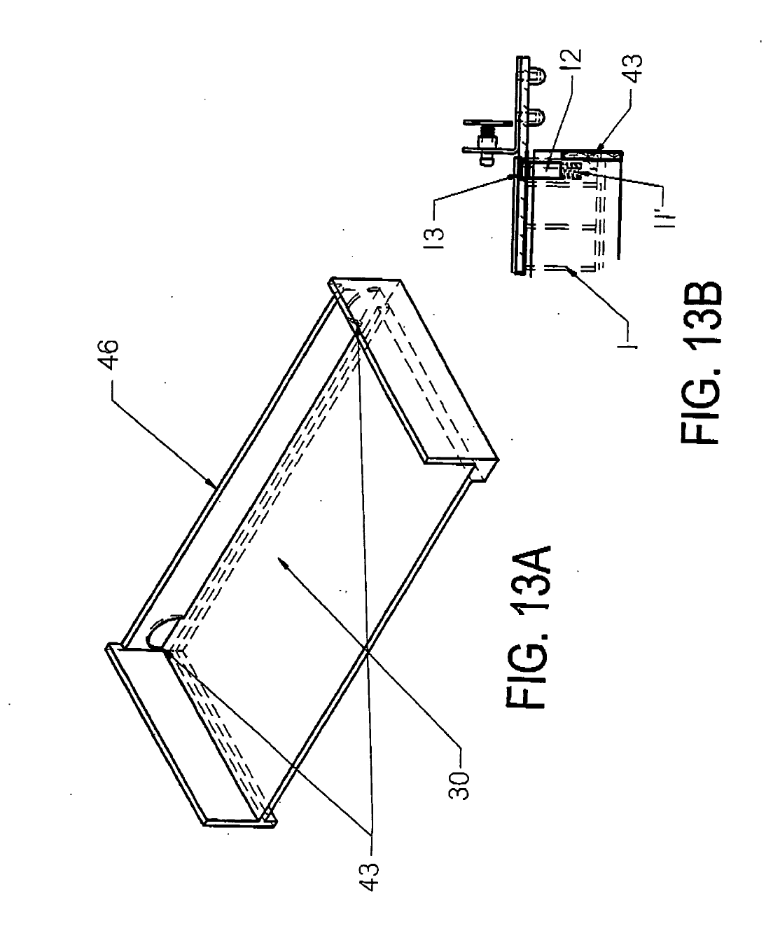

This embodiment of the cartridge 1 has been described with two sliding panels 5, each covering two rows of seven cells each. The two sliding panel approach was chosen to ensure rigidity taking into account the type of material used. However, the cartridge can be constructed using a single sliding panel covering the entire 28 cells; this option is shown in FIG. 18. Here, the panel 5′ has a longitudinal, central slot 5B′ along most of its length, terminating short of the inner end of the panel 5′ where it is attached to a single coupling means with this embodiment. It will be understood that the term“panel means” can refer to two panels or a single panel.

Inserting/Removing a Cartridge

To insert (remove) a cartridge into (from) the dispenser, the lid L of the dispenser is unlocked and raised. This allows access to the vertically movable access slider 25 as seen in FIGS. 2 and 11. Removing this slider 25 allows an operator access to the cartridge 1 and lower cell array 18 for cartridge changing. The access slider 25 can now be lifted up and out by pulling upward on thumb screw 44. By pulling on tab 56 as seen in FIGS. 2 and 3, the cartridge 1 and cell array 18 combination can be pulled outwards, to the left approximately two inches as seen in FIG. 12. This movement is controlled by slot 20 on the frame 27. FIGS. 2 and 12 show the cell array 18 in the open position. This action allows the couplers 8 on the cartridge to clear the dispenser face plate's 61 front edge 15. The empty cartridge can now be lifted upward and out. The filled cartridge can be inserted on to the three pins 22 of the cell array 18 and the cartridge cell array combination pushed to the right until it stops. The access panel 25 is returned to its position. It presses against the tab 56 on the cell array 18 holding the cartridge and cell array in place. Access to the access panel 25 is prevented when the lid L of the dispenser is closed and locked, The cartridge is now securely in place with its armature 10 pressing against its associated electromagnetic latches 16A and 16B.

Filling a Cartridge

The filling of a cartridge may be performed by a pharmacist using a loading dock 30, shown in FIG. 13, which device is dimensioned to receive a cartridge. The pharmacist slides the cartridge, with its sliding panels 5 uppermost, into the loading dock 30 from the open end, shown at left in FIG. 13, ensuring that the cartridge 1 is up against the loading dock closed end 46. This places the cartridge locking blocks 4′ firmly up against the loading dock magnets 43. These magnets are positioned to the right and below the center of the cartridge magnets 12 such that the magnetic fields of loading dock magnets 43 attract the cartridge magnets 12. This pulls the cartridge magnets 12 down against their springs 11′, clearing the cartridge magnets from the cavities 13 in sliding panels 5, thus allowing the sliding panels 5 to be removed. The pharmacist removes the two panels and proceeds with filling the cartridge according to the user's pill regimen. The sliding panels 5 are returned to the cartridge 1 and the cartridge is removed from the loading dock 30. On removal, the cartridge is again automatically locked. The pharmacist applies the appropriate label and the cartridge is ready for pickup. This completes the description of the cartridge.

Operational Detail

The following is a description of the operation of the preferred embodiment of Cartridge-Loaded Automatic Prescription Pill Dispensing System. The actions required to get the dispenser up and running where pills are dispensed at regular time periods will be presented. Related support operations will be described as required. Using an example, the dispenser will be stepped through one day's operation.

The actions to be described are as follows:

Set STDT/DLST on power up

Set time on power up

Set controls

Days of operation

Time periods and Time intervals

Loading sequence

Eject function

Fault conditions and reporting

Set STDT/DLST on Power Up

When the system is first powered up, all micro-controllers are initialized. The system does not know if it is standard time (STDT) or day light saving time (DLST). The STDT visual indicator (LED), by default, turns on green, indicating standard time. Day light saving time is from the first Sunday in April to the last Sunday in October.

If the system is turned on between the last Sunday in October and the first Sunday in April (STDT), the operator does nothing. The LED is green.

If the system is turned on between the first Sunday in April to the last Sunday in October (DLST) the operator has 10 minutes to press the change time button to change the status of the DEC_T bit in the micro-controller. The STDT LED also changes from green to red. The 10 minutes is arbitrarily set and is more than enough time to perform this task. After 10 minutes the change time button will change its function from a setup mode to a change time mode. It will stay in this mode until the dispenser is powered up again. Now pressing the change time button in the Spring and the Fall toggles the DEC_T bit and changing the LED. Making this button serve two functions, reduces the number of buttons on the control panel.

The initialization of the micro-controllers on power up sets other functions to their default states. These functions are listed as follows:

Time defaults to 1:00 a.m.

Cartridge setup LED defaults to requires setting—LED red

Noon row defaults to requires checking for empty cells—LED red

Time intervals defaults to early—LED off

Fourteen day mode defaults to seven day—LED off

Day Away defaults to unit is present or not used—LED green

Set Tie on Power Up

The time on the time display defaults to 1:00 a.m. Using the hours and minutes buttons set the time on the time display to the current time, Press the update time button to transfer this time to the main controller in the dispenser.

Set Controls

Check for Empty Cells

The first task in setting up the system after the first cartridge is inserted is to record, in the micro-controller, any empty cells in the cartridge. The Morning cells, by default, have pills in all seven cells (no empty cells), therefore, the software bypasses the setting up of these cells. The Noon, Afternoon and Evening time period cells could have empty cells, in fact, an entire seven cells of a time period could be empty. The reason that empty cells are recorded is so the micro-controller will know when not to activate the pills present audio and visual indicators. If they were activated on an empty cell, the user would respond by pressing the pill eject button and nothing would come out. This could confuse the user. This activity will be stepped through in the example below.

Set Early/Late Time Intervals

The system operates on four time periods: Morning, Noon, Afternoon and Evening. Each time period has two time intervals early or late. This gives the user the choice of when he/she would like to take the pills. The early time intervals are: 8 a.m., 12 p.m., 4 p.m. and 8 p.m. The late time intervals are: 9 a.m., 1 p.m., 5 p.m. and 9 p.m. The system defaults to early time intervals.

If the early time intervals are required, do nothing, the late time interval LED stays off.

If the late time intervals are required, press the late time interval button, a green LED turns on to inform the operator that the late time intervals have been selected.

Days of Operation

The system can dispense pills for seven days, which involves loading one full cartridge 1, or for fourteen days which involves loading a second full cartridge. The seven day loading action must be completed before the fourteen day loading action can be done. The fourteen day mode of operation is the preferred mode of operation. If a fourteen day mode is required, wait for the first loading action to complete (wait LED will turn off) then retrieve the cell array extender 77 from under the catch bin 42, via the access panel 71, and insert it into the slots provided by channel members 78A above the lower left hand wall 78 and press it firmly into position. Remove the empty cartridge and insert a second full cartridge. The fourteen day mode LED automatically turns on (green), informing the operator that the fourteen day mode is active. When the first seven days have passed, the contents of the second full cartridge are automatically transferred into the pill array 18. When in the fourteen day mode, the early warning signal, which occurs twelve hours before the system is empty, and the system empty signal are suppressed. These signals will be issued at the appropriate times at the end of fourteen days of operation.

When in the fourteen day mode, the operating time of the dispenser can be increased from fourteen to twenty-one days, without going through a complete reload procedure. This is accomplished by inserting a third full cartridge into the dispenser after the second cartridge has transferred its pills (now empty) and before the seventh day of the second cartridge arrives. This feature gives more flexibility to the operator as to when the dispenser is reloaded. If a third cartridge is not inserted, the fourteen day LED turns off on the first occurrence of the seventh day and the system reverts to a seven day mode. In this mode, the empty warning and empty alarms are enabled and will be issued at their appropriate times. If during the second week of a fourteen day mode of operation, the operator wants to perform a reload (before the first occurrence of the fourteenth day), the operator presses the fourteen day off button which forces the system to a seven day mode. In the seven day mode a full setup and reload can be performed.

Time Periods and Time Intervals

Pills are always moved from the lower cell array 18 to the remove slider repositories 37A and 37B one time period before they are to be used and on a late time interval. They occur at 9 a.m. for the Noon time period, 1 p.m. for the Afternoon time period, 5 p.m. for the Evening time period and at 2 a.m. for the Morning time period. Once the pills are in the remove slider repositories 37A and 37B, they are ejected when the eject button is pressed. This occurs at either the early or late time intervals depending on the setup. At 9 a.m., the Noon array slider 33B will be moved as described above and transfer the pills for 12 p.m. to the remove slider repositories 37A and 37B. For example, if the system was left in the default mode (early time intervals) and the next time period (Noon) is detected, the audio and visual indicators would be turned on. The user would respond by pressing the eject button 68 and the pills would be ejected to the external tray 26. The repositories are now empty. Say we have the same conditions except the late time intervals are selected. When the next time period (Noon) is detected, no alarms are sounded, therefore, the user does not respond. When 1 p.m. time interval is detected, the audio and visual indicators would be turned on. The user would respond by pressing the eject button 68 and the pills are ejected to the external tray 26. After this action is complete, the system would activate and load the next time period pills (Afternoon) into the remove slider repositories 37A and 37B. The system repeats this sequence through all time intervals until 9 p.m. is detected after which the system goes to sleep. It wakes up at 2 a.m., performs some housekeeping tasks, loads pills into the remove slider repositories 37A and 37B for the 8 a.m. time period and goes back to sleep until 8 a.m.

The reason that the system loads pills one time period ahead is to reduce the time it takes the user to receive the pills after the eject button is pressed. A worst case example would be if the system was on the seventh day of operation and the pills are taken directly from the pill array 18, as opposed to from the repositories 37A and 37B (placed there one time period before). After the user presses the eject button, the appropriate array slider moves seven cell positions and returns for a total of 23 seconds, Now the remove sliders 36A and 36B move two cell positions for an additional four seconds. This is a total of 27 seconds for the pills to drop into the external tray. If the pills were in the repositories, it would take four seconds for the pills to drop into the external tray 26.

Loading Sequence

Press the reload button, the Wait indicator turns on and the system automatically sequences through purge, transferring pills from cartridge to lower cell array, removal of purged pills to catch bin, and then transferring pills for next time period. This total process takes approximately one minute. These four functions are detailed below.

Purge

The purpose of the purge action is to clear out any pills left in the pill array 18 before a new set of pills are transferred from the cartridge 1. There could be pills left in the pill array 18 if the dispenser was reloaded after say thirteen days instead of the full fourteen days. This product supports a reload at any time. The purge action will automatically take place even if there are no pills in the lower cell array to remove.

The micro-controller activates all four time period electromagnetic latches 16C, D, E and F which binds the array sliders 33A, B, C and D to their electromagnetic latches 16C, D, E and F on the carriage PCB. The carriage is turned on and moves seven cell positions to the right, pulling the four sliders with it, This opens all cells and drops any remaining pills, in the 28 cell lower cell array 18 above, onto the floor 31 of the slider carrier 19. The carriage reverses after the back micro-switch 49 encounters back stop 59 and the four slider paddles 7 on the array sliders 19 sweep the pills ahead of it as the carriage goes to the home position. At the home position, the front micro-switch 57 encounters the front stop 53 and the carriage stops. The pills are dropped through the aperture 34 in the floor 31 of the slider carrier 19 into the remove sliders 36A and 36B repositories 37A and 37B below. The bottoms of all the pill array 18 cells are covered again. This completes the purge function. This function takes 23 seconds.

Cartridge Pill Transfer

The transfer of pills, in the cartridge 1, into the pill array 18 follows the purge action. The micro-controller activates the cartridge electromagnetic latches 16A and 166B which bind the cartridge slider couplers 8 to the cartridge electromagnetic latches. The carriage is turned on and moves seven cell positions to the right, pulling the two cartridge panels 5 with it. This action transfers all the pills in the twenty eight cells of the cartridge into the lower cell array 18. The carriage reverses after the back micro-switch 49 encounters back stop 59 and the carriage goes to the home position closing the cartridge panels 5. The front micro-switch 57 encounters the front stop 53 and stops. The cartridge is now empty and could be removed or left in place for storage. This function takes 23 seconds.

Before proceeding, note that the purge and cartridge pill transfer functions utilize the systems home 57 and back 49 micro-switches. When these functions are activated, the carriage always goes to the extreme right and back home. There is no cell counting. The three functions that follow namely, remove, eject and fill, can move a specific number of cell positions under the control of the micro-controller.

The leftover pills in the array have been purged and a new set of pills have been transferred from the cartridge to the pill array. The next step is to remove these leftover pills from the repositories to the catch bin 42. Refer to REMOVE FUNCTION for description of operation on page 35.

Pill Transfer After a Reload

After the remove action is complete, the system transfers pills from the lower cell array 18 to the repositories 37A and 37B in advance of the next time period. Normally the transfer occurs on the late (odd) time intervals, i.e. 9 a.m., 1 p.m., 5 p.m. and 9 p.m. in the normal sequencing mode. But after a reload, which can occur at any time, the first transfer occurs at the time of loading. Conditions in the micro-controller must be set to allow or not allow this transfer to occur for the following reasons: If the time intervals are set for early, e.g. 8 a.m., 12 pm, 4 pm, and 8 pm, and if the loading is done say Tuesday at 8.30 a.m. there is no issue of transferring the pills from the Morning period cell to the repositories immediately, instead of at the normal transfer time of 9 a.m., since pills are not going to be taken by the user at 9 a.m. When 9 a.m. is detected, the system will go through the motions of transferring pills but there are no pills in the lower cell array 18 (moved at 8:30) and therefore no harm is done. The pills will be taken at noon.

If the time intervals are set for late, i.e. 9 a.m., 1 p.m., 5 p.m. and 9 p.m., for the same loading time, then the pills must be transferred immediately so that they will be in the repository for 9 a.m. When 9 a.m. is detected, the alarms will be activated and the user will respond by pressing the eject button to get the pills. Also, after the eject action is complete, the system initiates a fill action and pills in the pill array for the Noon time period are transferred to the remove repositories, ahead of time, ready for the next time period, Noon. When the loading procedure is complete, the Wait visual indicator turns off, the operator closes the lid which locks. The system is now set for another week of operation.

Pill Transfer in Normal Operation

After the loading is complete, the system is idle until it detects the next time period (Noon). Since the time interval is in the default mode, when 12 p.m. is detected, the pills present visual and audible alarms are turned on and the eject function is enabled. If the user responds to the alarms and presses the Illuminated eject button 68, the eject function is activated. Refer to EJECT FUNCTION for description of operation. If the user does not respond within 28 minutes, the remove function is activated. Refer to REMOVE FUNCTION for description of operation. When these actions are complete the system is idle until the 1 p.m. time interval is detected. At that time, the micro-controller turns on the Afternoon electromagnetic latch 16E and the Afternoon array slider 33C is pulled one cell position to the right transferring the pills in the first Afternoon cell of the pill array 18 into the remove slider repositories 37A below. The carriage reverses and goes to the home position. The front micro-switch 57 encounters the front stop 53 and the carriage stops. The repositories now contain the pills for the Afternoon time period. When 4 p.m. is detected, the action is the same as described for 12 p.m. above.

If the time interval was set to late, and the next time period is Noon, the 12 p.m. time interval will produce no alarms, therefore, no response from the user. The system is idle until the 1 p.m. time interval is detected. At this time, the pills present visual and audible alarms are turned on and the eject function is enabled. If the user responds to the alarms and presses the Illuminated eject button 68, the eject function is activated. Refer to EJECT FUNCTION for description of operation. If the user does not respond within 28 minutes, the remove function is activated, Refer to REMOVE FUNCTION for description of operation. When this action is complete the fill function is activated and pills transferred to the repositories for the Afternoon time period as described above.

Eject Function

The eject function is enabled when the pills present visual and audible alarms are active. The user responds by pressing the illuminated eject button 68 on the front visual panel. The eject electromagnetic latches 16I and 16J are energized and binds the eject slider couplers 40 to the eject electromagnetic latches 16I and 16J. The carriage is turned on and moves two positions to the right, pulling the two eject sliders 38A and 38B with it. This action allows the pills in the remove slider repositories 37A and 37B to drop down the chute 41A, as shown as a dotted line in FIG. 3, into the external tray 26 on the left side of the dispenser.

If the user fails to respond to the pills present alarms after 28 minutes, the remove function is activated and the pills in the repositories are placed in the catch bin 42 as described in the remove function.

Remove Function

The remove function is a safety mechanism that removes pills from the remove slider repositories to the catch bin 42 if the user does not respond and eject the pills within 28 minutes of the sounding of the pill present audio device. After the pills are removed, the alarms are turned off and the remote reporting system sends a Code 3 call to the pager to inform the operator that pills were not taken. The operator responds accordingly.

NOTE: The remove mechanism is the same regardless if it occurs after a purge action or a 28 minute delay.

The micro-controller activates the remove electromagnetic latches 16G and 16H and binds them to the remove slider couplers 32B. The carriage turns on and moves two positions to the right, pulling the two remove sliders 36A and 36B with it. This action transfers all the pills in the remove slider repositories 37A and 37B into the catch bin 42 below. The carriage reverses direction and moves to the home position. The front micro-switch 57 encounters the front stop 53 and the carriage stops. The remove sliders 36A and 36B are at their home position. These pills will remain in the catch bin 42 until the reload action is complete or the next time the operator goes to the user's resident to reload the dispenser. In either case, the operator opens the access panel 71 and removes the catch bin 42, retrieving any pills in it. The catch bin 42 and access panel 71 are returned. This function takes 8 seconds.

Fault Conditions and Reporting

When one of the seven system conditions occur, the dispenser seizes the telephone line and sends a call to the person that is calling the pager. This person could be a member of the family or an assigned caregiver. It is the responsibility of this person to respond accordingly. The codes are described below.

Code 1—Help Me. This code is sent when the user pushes the button on a pendant or bracelet as a call for help. This is the most serious code and must be responded to immediately.

Code 2—System Failure. This code is generated by the system when a major failure occurs such as a forced system shutdown due to a timing fault, a loss of internal power or when the dispenser is empty of pills. This code must be responded to as soon as possible.

Code 3—Pills not Taken. This code is sent as a status condition. The operator would call the user to determine why the pills were not taken.

Code 4—Empty Warning. This code is sent twelve hours before the dispenser is empty. It is a reminder to the operator to fill the dispenser within twelve hours.

Code 5—External Power Failure/Loss of Charging. This is considered a minor call since the system backup power will maintain operation for 24 hours. This gives the operator time to respond. In the case of major system failure, the operator can implement the external control feature where the unit may be connected vie a jumper plug to an external control unit which supplies power to the carriage and controls the purge and eject functions. In this way, any remaining pills in the dispenser can be removed before the dispenser is taken from the user's residence.

Code 6—Day Away Removed. This call notifies the operator that the user has removed the Day Away from the main dispenser. This is important since removing the Day Away forces the main dispenser to stop dispensing pills. This is done for safety reasons to prevent the user from taking pills from both units in the same time period.

Code 7—Day Away Returned. Knowing that the Day Away has been removed, the operator is expecting the Day Away to be returned at some reasonable time in the future. If the return call is not received, the operator must call to determine the status of the user. Usually it will be simply that the user forgot to return the Day Away to its holder.

Code 1 must be transmitted from the pill dispenser immediately. My old design, shown in my '220 Canadian patent, monitored the telephone line and seized it when it was free (on hook). With the introduction of the Help Me feature, it was necessary to develop an approach where the dispenser could seize the telephone line even if it is in use by the user or is left off hook. This is accomplished by passing the incoming telephone line through a relay in the dispenser and then to a remote jack which is plugged into a power outlet. The remote jack transmitter uses the house wiring to transmit the telephone signals to a receiver which is plugged into a different power outlet in another room. The user's phone is plugged into this receiver and not into a normal telephone jack. If the dispenser needs to report a condition and the telephone line is off hook, the microprocessor energizes the relay which removes the off hook condition from the line, allowing the dispenser to seize the line and send a call to the pager. This breaks the line from the user for a period of 16 seconds.

Another safety feature is a circuit that constantly monitors the telephone connection to the phone line. If this connection is broken (phone removed from the wall jack), the dispenser produces an audible alarm to which the user should respond.

Normal Operating Mode

The best way to present a clear picture of the operation of this product is by example. This example traces the operation of the dispenser over a typical day. The system has been operating in normal mode for months. Power up conditions do not apply.

The operator arrives at the user's residence at 8:30 a.m. of the fourteenth day to reload the dispenser. Since the dispenser is on the fourteenth day, the fourteen day LED is off and a complete reload procedure is required. The dispenser is unlocked and the empty cartridge is removed and a filled cartridge inserted as described in the section INSERTING/REMOVING A CARTRIDGE. The cartridge LED turns on (red) as soon as the new cartridge is inserted. This indicates that the cartridge must be checked for empty cells. Since the 7 cells of the Morning row have pills in all seven cells by default, the system starts the checking at the Noon row by turning on the Noon LED (red). The operator scans the Noon row for empty cells, if all seven cell are full the operator presses the ENTER button. Say cell 4 is empty, the operator sets the code switch to 4 and presses RECORD. The single digit empty display confirms the cell selection by shows the digit 4. If this is the correct cell, press RECORD again. If it is incorrect, do nothing, the display will turn off. Repeat the setup. If there are no other empty cells the operator presses ENTER. The Noon LED turns off and the Afternoon LED turns on (red). The operator repeats this procedure through to the Evening row. When the checking of the Evening row cells is complete the ENTER button is pressed, the Evening LED turns off and the cartridge LED changes to green. This completes checking for empty cells.

If during the above process, all cells of a particular row are empty, set the code switch to Zero. The empty display will show “A”. If this is correct press RECORD.

NOTE: The reload button is inhibited until the cartridge LED is on (green). The next step is to select early or late mode of operation. The system defaults to early time intervals and the time interval LED is off. If the late time intervals is desired, the time interval button is pressed and the LED turns on (green). In this example, the system is left in the default condition which is early time intervals. This completes the setup, now the system must be loaded.

The operator presses the red RELOAD button. The Wait LED turns on (red) and the loading sequence commences. Refer to the section LOADING SEQUENCE for a description of the four loading actions. When the four loading actions are complete, the Wait LED turns off and the loading of the first cartridge is complete.

The procedure stops here if a seven day operation is required. Return the catch bin 42, the access panel 71 and the access slider 25 to their positions and close the lid L. It will lock and prevent access to these parts. The system is set to automatically dispense pills for seven days.

For example, if a fourteen day operation is required (preferred mode of operation), a second full cartridge is installed as described in the section DAYS OF OPERATION.

If the caregiver arrived at the user's residence at 8:40 a.m. of the thirteenth day to reload the system, the fourteenth day LED is still on, therefore, a normal setup is averted and the following short procedure is performed.

The dispenser is unlocked and the empty cartridge (second cartridge) is removed and a filled third cartridge inserted as described in the section DAYS OF OPERATION. The cartridge LED turns on (red) as soon as the third cartridge is installed indicating that this new cartridge must be checked for empty cells. The test for empty cells is performed as described above and the fourteen day LED stays on (green). The access panel 71 and the vertical access slider 25 are returned, the lid is closed and locked. The system is again operational for another week. NOTE: If the active cartridge is more than 2 days into operation, the pill array extender is not required (the first 2 collums of pills have been empted).

At the end of the second week, the system automatically transfers the pills of the third cartridge and the system will continue to dispense pills for a third week. This procedure can be repeated indefinitely.

Now back to the example, when the loading is complete. Since the operator started the reload action at 8:40 a.m., the next time period is Noon (12 p.m.) and the time interval was set to early. The system is idle until 12 p.m. is detected. When it is detected, the eject function is enabled and the pills present alarms turned on. The system waits for the user to respond. If the user responds by pressing the illuminated eject button 68, the system activates the eject action as described in section EJECT FUNCTION. If the user does not respond within 28 minutes, the remove function is activated as described in section REMOVE FUNCTION.

The system remains idle until the next time interval is detected by the micro-controller which, in this example, is 1 p.m. When 1 p.m. is detected, there are no audible and visual indicators turned on since the early time intervals were selected during setup. There is no response by the user. The system initiates a fill action and pills in the pill array 18 for the Afternoon time period are transferred to the remove repositories 37A and 37B, ahead of time, ready for the next time period, Afternoon. Refer to section PILL TRANSFER IN NORMAL OPERATION for details.

The system again remains idle until the next time interval is detected by the micro-controller which, in this example, is 4 p.m. Since the system is in early time interval mode, the micro-controller initiates the pills present visual and audible alarms. The user responds by pressing the illuminated eject button 68 on the front visual panel. The eject function activates and pills are placed in the external tray 26.

At 5 p.m. the micro-controller initiates a fill action and by the same action as described above, pills are transferred from the first cell of the Evening row into the repositories and waits for the 8 p.m. time interval to be detected. When detected, the pills present alarms will sound and the system waits for the user to respond, The system will continue with this sequence of events four times a day for seven days.

If the user does not respond after twenty eight minutes, the micro-controller will initiate the remove function as described above and the pills in the remove slider repositories will be transferred to the catch bin 42 and a Code 3 is sent to the operator.

If the operator does not come to reload the system, on the first occurrence of the fourteenth day, an empty warning Code 4 is sent to the operator, reminding the operator that the system requires refilling within 12 hours. If the system is not filled when the 12 hours is up an empty Code 2 is sent to the operator and the system shuts down. This Code 2 is repeated every four hours until action is taken.

At 9 p.m. the system goes to sleep and wakes up a 2 a.m. to do some house keeping tasks then transfers pills to the repositories for 8 a.m. This completes one day of operation. This cycle repeats for fourteen days.

Optional Features

There are three optional features associated with this Automatic Prescription Pill Dispensing System as listed below:

Day Away

Help Me

Hearing Impaired Visual Aid

Day Away

This device was fully disclosed in Canadian Patent No. 2,217,220 granted May 2001. Its description is repeated here for continuity.

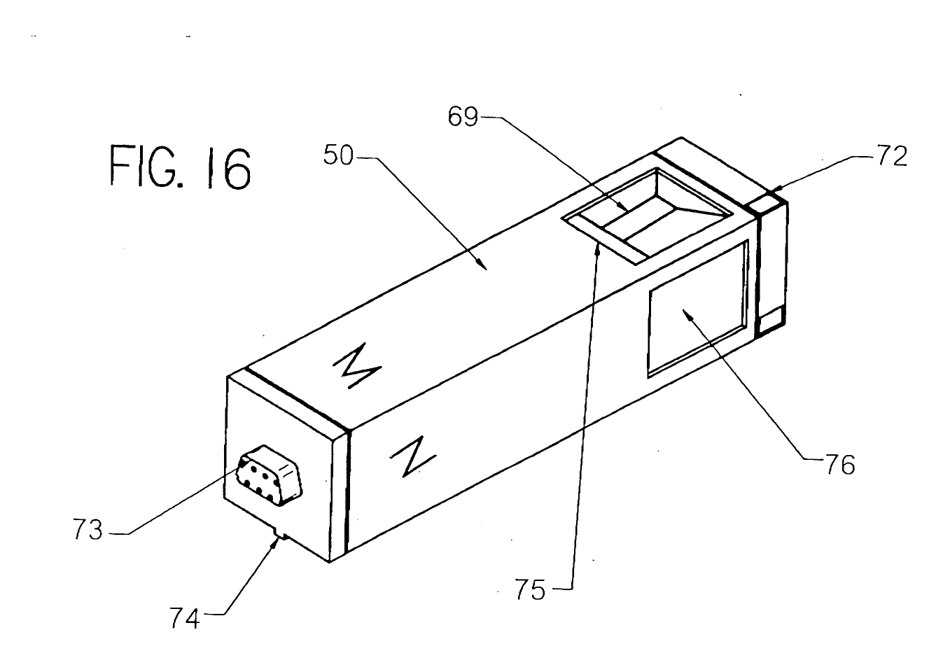

This is a hand held device 50 composed of four cells 69, one mounted on each face of the device 50, see FIG. 16. The cells are covered by locked thumb operated sliders 76. One of the sliding covers 75 is open to show the pill cell 69. The device holds a small number of essential pills required for the well being of the user for one day. The unit communicates with the main dispenser through connector 73. Tab 74 is a key that forces the Day Away to align correctly with the connector in the holder (it can only be inserted one way). When removed from its holder 70 on the right side of the main dispenser, the main dispenser will send a Code 6 to the pager carried by the caregiver assigned to that particular dispenser. Also, the main dispenser will stop dispensing pills while the Day Away is removed from its holder. The main dispenser continues to function but the pills present alarms and the reporting of Code 3 is inhibited. The pills are transferred to the catch bin 42. A Code 7 is issued when the Day Away is returned. The purpose of these warning codes is to make the operator aware that the user's dispenser is inhibited while the Day Away is out of its holder. If the unit is not returned after a reasonable length of time, the operator should check on the user. This feature is activated by setting jumpers on the back PCB.

Help Me

This feature adds additional support to the elderly. A typical situation is if the user should fall and cannot get up. The user wears a pendant or a bracelet that has a button which can be pressed if the user is in trouble. A signal is transmitted to the dispenser which in turn reports a Code 1 to the caregiver carrying the pager. This call will repeat every ten minutes. The caregiver must respond immediately with a preset action plan. The final action of this plan is to go to the user's residence to ensure that the actions put into motion were carried out. Only after the immediate problem has be alleviated, can the caregiver turn his/her attention to the dispenser and cancel the continuous transmission of Code I by pressing the pager off button twice. The pager off LED on the front visual panel will turn on and off. This feature is activated by setting a jumper on the back PCB.

Hearing Impaired Visual Aid

If the user is hearing impaired, an option is available where the pills present audible alarm is supplemented with a flashing lamp. The lamp can be in any room in the user's residence. This flashing lamp operates the same way as the audible alarm, in that it flashes for 20 seconds, turns off for 9 minutes then flashes again. It repeats this action for 28 minutes. This feature is activated by setting a jumper on the back PCB.

The contents of the various patents mentioned hereinbefore are incorporated herein by reference.

Although embodiments of the invention have been described and illustrated in detail, it is to be clearly understood that the same is by way of illustration and example only and not to be taken by way of the limitation, the spirit and scope of the present invention being limited only by the appended claims.

I claim:

1. An automatic prescription pill dispensing system comprising, in combination, a dispensing unit and a removable cartridge,
the removable cartridge comprising:
a rectangular, normally horizontal upper array of pill-retaining cells for holding pills to be loaded into the dispensing unit, each of the cells having an open bottom closable by sliding bottom panel means, said sliding bottom panel means being able to slide between a closed position such that pills in the cells are prevented from falling through the cells, and an open position such that pills fall from the bottoms of the cells,
the dispensing unit comprising:
a lower rectangular array of pill-retaining cells corresponding to the upper pill-holding cell array of the cartridge, said lower pill-retaining cells being adapted for retaining pills to be dispensed, each of the lower pill-retaining cells being open at the top to permit pills to fall into the lower pill-retaining cells from the cartridge when the cartridge is installed over the lower cell array and when said sliding bottom panels means is open;
said dispensing unit including powered means for moving the sliding bottom panel means of the removable cartridge when the cartridge is installed over the lower cell array to open the sliding panel means and to permit pills in the cartridge to fall into the lower cell array;
a plurality of array slider means located under the lower cell array to act as a pill-retaining floor for the pill-retaining cells of the lower cell array when in a filly closed position, said slider mans being selectively movable predetermined distances from a closed position to several different open positions to permit pills from a desired pill-retaining cell of the lower cell array to drop into a pre-dispensing location;
the dispensing unit further comprising array slider movement means associated with each of the array slider means for selectively moving each of the array slider means predetermined distances between said closed and open positions;
user-operable dispenser means to cause movement of pills from the pre-dispensing location to a dispensing location where they may be accessed by the user; and
microprocessor means for controlling the movement of the array slider means to permit dispensing of pills;
whereby pills to be dispensed may be loaded into the removable cartridge, which is then installed in the dispensing unit in order to transfer the pills to be dispensed from the upper cell array of the cartridge into the lower cell array of the dispensing unit, and pills to be dispensed may then be moved at an appropriate time from the lower cell array to the pre-dispensing location.

2. The combination of claim 1, wherein said cartridge has a fixed clear cover over the tops of said upper pill retaining cells when the cartridge is in its normal horizontal orientation, the cartridge being adapted for filling with pills when removed from the unit and inverted, and when said bottom panel means has been opened.

3. The combination of claim 1, wherein said microprocessor means also controls movement of the sliding bottom panel means of the cartridge, so that an initial supply of pills may be loaded into the cartridge and transferred from the upper pill array into the lower cell array in an initial operation, whereupon the cartridge may be removed and replaced with a cartridge filled with a second supply of pills, and wherein said microprocessor then controls the sliding bottom panel means so that the second supply of pills is only released from the cartridge into the lower cell array when the initial supply of pills in said lower cell array has been exhausted.

4. The combination of claim 1, wherein said powered means for moving said bottom panel means include an electrically powered carriage which is connectible selectively either to said bottom panel means or to said array slider means.

5. The combination of claim 4, wherein said electrically powered carriage has electromagnets the energization of which is controlled by said microprocessor, said bottom panel means of the cartridge and the array slider means having ferromagnetic elements adapted to be moved by said electromagnets when the latter are energized.

6. The combination of claim 1, wherein the cartridge has locking means for said bottom panel means which normally prevent said bottom panel means from being opened when the cartridge is removed from the dispensing unit, said dispensing unit having means for releasing said locking means when the cartridge is placed in said dispensing unit, and wherein the combination also includes a docking station, for use when the cartridge is being charged with pills, and which also has means for releasing said locking means.

7. The combination of claim 6, wherein said locking means includes a magnetically operated latch connecting the upper pill-holding array of the cartridge to the bottom panel means, and wherein said dispensing unit and said docking station both have magnets for releasing said magnetic latches.

8. The combination of claim 7, wherein said magnetically operated latch includes a magnetically operated latch member held by the upper pill-holding array of the cartridge and urged outwardly by spring means, and a corresponding cavity in said bottom panel means engageable by said magnetically operated latch member.

9. A method for automatically dispensing prescription pills using a combination of a dispensing unit and a removable cartridge, comprising the steps of:
placing a supply of said pills into the cartridge, the cartridge having a rectangular, normally horizontal upper array of pill-retaining cells, in which each of the cells has an open bottom closable by sliding bottom panel means, said sliding bottom panel means being able to slide between a closed position such that pills in the cells are prevented from falling through the cells, and an open position such that pills fall from the bottoms of the cells,
placing said cartridge into the dispensing unit, said unit having a lower cell array comprising a rectangular array of lower pill-retaining cells corresponding to the upper pill-holding cell array of the cartridge, said lower pill-retaining cells being adapted for retaining pills to be dispensed,
energizing powered means in said dispenser unit operable to open said sliding bottom panel means to permit pills to fall into the lower pill-retaining cells from the cartridge;
initiating powered movement of a plurality of array slider means located under the lower cell array, said slider mans being selectively moved predetermined distances from a closed position to several different open positions on a predetermined schedule controlled by microprocessor means, to permit pills from a desired pill-retaining cell of the lower pill-holding array to drop into a pre-dispensing location,
initiating user-operable dispenser means to cause movement of pills from the pre-dispensing location to a dispensing location where they may be accessed by the user.

10. A process according to claim 9, wherein, after an initial supply of said pills have fallen from said upper pill-holding cell array of the cartridge into the lower pill-holding cell array upon initial opening of said bottom panel means, the cartridge is removed and replaced by a cartridge filled with a second supply of pills, and wherein said microprocessor means is arranged automatically to open the bottom panel means, to release said second supply of pills, only when the initial supply of pills has been exhausted.

11. A removable cartridge for use with a dispensing unit of an automatic prescription pill dispensing system, the cartridge comprising a rectangular, normally horizontal upper array of pill-retaining cells for holding pills to be loaded into the dispensing unit, each of the cells having an open bottom closable by sliding bottom panel means, said sliding bottom panel means being able to slide between a closed position such that pills in the cells are prevented from falling through the cells, and an open position such that pills fall from the bottoms of the cells; the dispensing unit comprising a lower rectangular array of pill-retaining cells corresponding to the upper pill-holding cell array of the cartridge, said lower pill-retaining cells being adapted for retaining pills to be dispensed, each of the lower pill-retaining cells being open at the top to permit pills to fall into the lower pill-retaining cells from the cartridge when the cartridge is installed over the lower cell array and when said sliding bottom panels means is open; said sliding bottom panel means of the removable cartridge being operable by powered means of the dispensing unit when the cartridge is installed over the lower cell array to open the sliding panel means and to permit pills in the cartridge to fall into the lower cell array.

12. A dispensing unit for use in an automatic pill dispensing system in combination with a removable cartridge having a rectangular, normally horizontal upper array of pill-retaining cells for holding pills to be loaded into the dispensing unit, each of the cells having an open bottom closable by sliding bottom panel means, said sliding bottom panel means being able to slide between a closed position such that pills in the cells are prevented from falling through the cells, and an open position such that pills fall from the bottoms of the cells, the dispensing unit comprising;
a lower rectangular array of pill-retaining cells corresponding to the upper pill-holding cell array of the cartridge, said lower pill-retaining cells being adapted for retaining pills to be dispensed, each of the lower pill-retaining cells being open at the top to permit pills to fall into the lower pill-retaining cells from the cartridge when the cartridge is installed over the lower cell array and when said sliding bottom panels means is open;
powered means for moving the sliding bottom panel means of the removable cartridge when the cartridge is installed over the lower cell array to open the sliding panel means and to permit pills in the cartridge to fall into the lower cell array;
a plurality of array slider means located under the lower cell array to act as a pill-retaining floor for the pill-retaining cells of the lower cell array when in a fully closed position, said slider mans being selectively movable predetermined distances from a closed position to several different open positions to permit pills from a desired pill-retaining cell of the lower cell array to drop into a pre-dispensing location;
array slider movement means associated with each of the array slider means for selectively moving each of the array slider means predetermined distances between said closed and open positions;
user-operable dispenser means to cause movement of pills from the pre-dispensing location to a dispensing location where they may be accessed by the user; and
microprocessor means for controlling the movement of the array slider means to permit dispensing of pills;
whereby pills to be dispensed may be loaded into the removable cartridge, which is then installed in the dispensing unit in order to transfer the pills to be dispensed from the upper cell array of the cartridge into the lower cell array of the dispensing unit, and pills to be dispensed may then be moved at an appropriate time from the lower cell array to the pre-dispensing location.
